(19) United States
(12) Patent Application Publication
(10) Pub. No.: US 2014/0061486 A1
(43) Pub. Date: Mar. 6, 2014

(54) Spectrometer Devices

(71) Applicant: Massachusetts Institute of Technology, (US)

(72) Inventors: Jie Bao, Cambridge, MA (US); Moungi G. Bawendi, Cambridge, MA (US)

(21) Appl. No.: 13/773,108

(22) Filed: Feb. 21, 2013

Related U.S. Application Data
(60) Provisional application No. 61/601,276, filed on Feb. 21, 2012.
(60) Provisional application No. 61/692,231, filed on Aug. 22, 2012.

(51) Int. Cl. G01J 3/28

(52) U.S. Cl. CPC G01J 3/28
USPC 250/370.01; 250/372; 29/592; 29/25.01

(57) ABSTRACT

A spectrometer can include a plurality of semiconductor nanocrystals. Wavelength discrimination in the spectrometer can be achieved by differing light absorption and emission characteristics of different populations of semiconductor nanocrystals (e.g., populations of different materials, sizes or both). The spectrometer therefore can operate without the need for a grating, prism, or a similar optical component. A personal UV exposure tracking device can be portable, rugged, and inexpensive, and include a semiconductor nanocrystal spectrometer for recording a user's exposure to UV radiation. Other applications include a personal device (e.g. a smartphone) or a medical device where a semiconductor nanocrystal spectrometer is integrated.

### CLAIM OF PRIORITY

This application claims the benefit of prior U.S. Provisional Application No. 61/601,276, filed on Feb. 21, 2012, and U.S. Provisional Application No. 61/692,231, filed on Aug. 22, 2012, each of which is incorporated by reference in its entirety.

### FEDERALLY SPONSORED RESEARCH OR DEVELOPMENT

This invention was made with government support under Contract No. W911NF-07-D-0004 awarded by the Army Research Office. The government has certain rights in the invention.

### TECHNICAL FIELD

This invention relates to spectrometer devices, including UV tracking devices, and methods of making and using them.

### BACKGROUND

A spectrometer is an instrument used to measure the intensity of light in different sections of the electromagnetic spectrum. Because the intensity of light at different wavelengths carries specific information about the light source, such as a signature of its chemical composition, spectrometer has found wide application in astronomy, physics, chemistry, biology, medical applications, energy, archaeology and other areas. Spectrometers used today are based on the original design from the nineteenth century, where a prism or diffraction grating sends light of different wavelengths in different directions, allowing the intensity at different wavelengths to be measured. One use of a spectrometer is to record the intensity of harmful UV rays, and differentiate the intensity of different UV wavelength bands.

### SUMMARY

In one aspect, a spectrometer includes a plurality of detector locations, wherein each detector location includes a plurality of semiconductor nanocrystals capable of absorbing a predetermined wavelength of light, and where each detector location includes a photosensitive element capable of providing a differential response based on differing intensity of incident light; and a data recording system connected to each of the photosensitive elements, wherein the data recording system is configured to record the differential responses at each of the detector locations when the detector locations are illuminated by incident light.

The plurality of semiconductor nanocrystals at each detector location can be capable of absorbing a different predetermined wavelength of light. The photosensitive elements can include photovoltaic cells. The photosensitive elements can be photoconductors. The semiconductor nanocrystals, after absorbing the predetermined wavelength of light, can be capable of emitting a distinct wavelength of light, and the photosensitive element can be sensitive to the distinct wavelength of light.

The semiconductor nanocrystals can be configured to absorb substantially all of the predetermined wavelength of light incident at a particular detector location, and substantially incapable of emitting a distinct wavelength of light.

In another aspect, a method of recording a spectrogram includes providing a spectrometer including: a plurality of detector locations, where each detector location includes a plurality of semiconductor nanocrystals capable of absorbing a predetermined wavelength of light, and wherein each detector location includes a photosensitive element capable of providing a differential response based on differing intensity of incident light; and a data recording system connected to each of the photosensitive elements, wherein the data recording system is configured to record the differential responses at each of the detector locations when the detector locations are illuminated by incident light; illuminating the plurality of detector locations with incident light; recording the differential responses at each of the detector locations; and determining the intensity of a particular wavelength of incident light based on the recorded differential responses at each of the detector locations. The spectrometer can include computational, memory or display components, or combinations thereof. The spectrometer can be used in diagnostic tool or spectral imaging devices.

In another aspect, a personal UV exposure tracking device includes a UV detector that can discriminate between different wavelengths in the UV region; and a data recording system configured to record differential responses to the different wavelengths in the UV region when the detector locations are illuminated by incident light.

The UV detector can be a UV sensitive semiconductor photodetector. The UV photodetector can be a photodetector array. The UV detector can be a nanocrystal spectrometer. The nanocrystal spectrometer can include a plurality of detector locations, where each detector location includes a plurality of semiconductor nanocrystals capable of absorbing a predetermined wavelength of light, and where each detector location includes a photosensitive element capable of providing a differential response based on differing intensity of incident light; and the data recording system can be connected to each of the photosensitive elements, where the data recording system is configured to record the differential responses at each of the detector locations when the detector locations are illuminated by incident light.

The spectrometer can be configured to measure the intensity of one or more UV wavelengths of incident light. The spectrometer can be configured to measure the intensity of UVA, UVB, and UVC wavelengths of incident light. The personal UV exposure tracking device can further include a data storage component configured to record the measured intensity of one or more UV wavelengths of incident light. The personal UV exposure tracking device can further include a wireless data communication system configured to transmit the measured intensity of one or more UV wavelengths of incident light to an external computing device. The device can be configured to provide a real time measurement of UV exposure to a user. The device can be configured to provide a historical report of UV exposure to a user. The device can be integrated in a portable personal item. The portable personal item can be waterproof.

In another aspect, a spectrometer can include a plurality of detector locations, wherein each detector location includes a light absorptive material capable of absorbing a predetermined wavelength of light, the light absorptive material being selected from the group consisting of a semiconductor nanocrystal, a carbon nanotube and a photonic crystal, and wherein each detector location includes a photosensitive element capable of providing a differential response based on differing intensity of incident light and a data recording system connected to each of the photosensitive elements, wherein the data recording system is configured to record the differential responses at each of the detector locations when the detector locations are illuminated by incident light.

In certain embodiments, the spectrometer can include a plurality of detector locations that include a filter including a semiconductor nanocrystal. In certain embodiments, the photosensitive element can include a semiconductor nanocrystal. For example, the plurality of detector locations can include a filter including a first semiconductor nanocrystal through which light passes prior to the photosensitive element, the photosensitive element including a second semiconductor nanocrystal.

In another aspect, a method of making a spectrometer can include creating a plurality of detector locations, wherein each detector location includes a light absorptive material capable of absorbing a predetermined wavelength of light, the light absorptive material being selected from the group consisting of a semiconductor nanocrystal, a carbon nanotube and a photonic crystal, and wherein each detector location includes a photosensitive element capable of providing a differential response based on differing intensity of incident light; and connecting a data recording system to each of the photosensitive elements, wherein the data recording system is configured to record the differential responses at each of the detector locations when the detector locations are illuminated by incident light.

In certain embodiments, creating the plurality of detector locations can include inkjet printing or contact transfer printing the light absorptive material on a substrate.

In certain embodiments, creating the plurality of detector locations can include forming a vertical stack of a plurality of semiconductor nanocrystal photo detectors, and can optionally, include assembling a plurality of vertical stacks to form a matrix of vertical stacks.

In another aspect, a method of making a spectral imaging device can include creating a plurality of detector locations, wherein each detector location includes a light absorptive material capable of absorbing a predetermined wavelength of light, the light absorptive material, and wherein each detector location includes a photosensitive element capable of providing a differential response based on differing intensity of incident light; and connecting a data recording system to each of the photosensitive elements, wherein the data recording system is configured to record the differential responses at each of the detector locations when the detector locations are illuminated by incident light.

In certain embodiments, creating the plurality of detector locations can include forming a vertical stack of absorptive layers, each absorptive layer having a different light absorptive characteristic. The method can further include assembling a plurality of vertical stacks to form a matrix of vertical stacks.

In certain embodiments, creating the plurality of detector locations can include forming a horizontal plate of absorptive patches, each patch having a different light absorptive characteristic. The size of each patch can be between 1 μm² and 1000 mm². In certain circumstances, the patch can be even larger, and can have any shape. The size of the horizontal plate can be between 1 μm² and 0.9 m².

In certain embodiments, a method of making a spectral imaging device can include using the light absorptive material selected from the group consisting of a semiconductor nanocrystal, a carbon nanotube and a photonic crystal.

In another aspect, a plate reader can include a plurality of spectrometers and a plurality of wells, wherein each well is associated with a unique spectrometer of the plurality of spectrometers, each spectrometer comprising a plurality of detector locations, wherein each detector location includes a light absorptive material capable of absorbing a predetermined wavelength of light, the light absorptive material, and wherein each detector location includes a photosensitive element capable of providing a differential response based on differing intensity of incident light; and a data recording system to each of the photosensitive elements, wherein the data recording system is configured to record the differential responses at each of the detector locations when the detector locations are illuminated by incident light.

In certain embodiments, the light absorptive material is selected from the group consisting of a semiconductor nanocrystal, a carbon nanotube and a photonic crystal.

In another aspect, a personal device can include a spectrometer can include a plurality of detector locations, wherein each detector location includes a plurality of semiconductor nanocrystals capable of absorbing a predetermined wavelength of light, and wherein each detector location includes a photosensitive element capable of providing a differential response based on differing intensity of incident light; and a data recording system connected to each of the photosensitive elements, wherein the data recording system is configured to record the differential responses at each of the detector locations when the detector locations are illuminated by incident light.

In certain embodiments, the personal device can be a smartphone or a smartphone attachment.

In another aspect, a medical device can include a spectrometer with a plurality of detector locations, wherein each detector location includes a plurality of semiconductor nanocrystals capable of absorbing a predetermined wavelength of light, and wherein each detector location includes a photosensitive element capable of providing a differential response based on differing intensity of incident light; and a data recording system connected to each of the photosensitive elements, wherein the data recording system is configured to record the differential responses at each of the detector locations when the detector locations are illuminated by incident light.

Other aspects, embodiments, and features will be apparent from the following description, the drawings, and the claims.

### BRIEF DESCRIPTION OF THE DRAWINGS

FIG. 1A is a schematic depiction of a spectrometer. FIG. 1B shows absorption spectra of a number of different populations of semiconductor nanocrystals.

FIG. 2 is a schematic depiction of an electro-optical device such as a photovoltaic cell.

FIGS. 3A-3E are schematic depictions of different configurations of photovoltaic devices.

FIG. 4A is a schematic depiction of an electro-optical device. FIG. 4B is a schematic depiction of an alternative electro-optical device.

FIG. 5 is a schematic depiction of a temporal or spatial separations with dispersive optics or interference based filters.

FIG. 6 is a schematic depiction of an optical measurement setup for a semiconductor nanocrystal spectrometer.

FIG. 7A is a series of graphs showing the responsivity function taken from a calibrated Si photodiode. FIG. 7B is a series of graphs showing the individual transmission spectra (Tᵢ(λ)) of the quantum dot filters (Fᵢ) shown in FIG. 3. FIG. 7C is a series of graphs showing transmitted light intensities Iᵢ for each light source and spectra reconstructions.

FIG. 8A is a depiction of a series of semiconductor nanocrystal filters. FIG. 8B are select transmission spectra of some of the filters shown in FIG. 8A.

FIG. 9 represents a series of graphs showing reconstructed spectra of 6 different light sources by the semiconductor nanocrystal spectrometer.

FIG. 10A is a schematic depiction of an integrated spectrometer. FIG. 10B is an example of an integrated spectrometer. FIG. 10C are spectra obtained using the integrated spectrometer.

FIG. 11A is a depiction of a semiconductor nanocrystal detector. FIG. 11B is a depiction of a vertically stacked semiconductor nanocrystal detector. FIG. 11B is a depiction of a vertically stacked semiconductor nanocrystal detector. FIG. 11C is a depiction of the repeated stacked detectors forming a matrix of sensors. FIG. 11D is a schematic depiction of the spectral imaging lambda stack.

FIG. 12 is a schematic diagram depicting of forming a horizontal plate with multiple absorptive patches of semiconductor nanocrystals.

### DETAILED DESCRIPTION

Current spectrometers are bulky, heavy, expensive, delicate, and complicated to use. The need for delicate optical components, such as a prism or grating, makes spectrometers heavy and expensive. Components must be kept extremely clean and perfectly aligned, making manufacturing expensive and the instrument very delicate. Once optical components get out of alignment, it is very complicated to repair, leading to high maintenance costs. The instruments can be very complicated for users to operate. Spectrometers are therefore not practical for many applications. There is a need for inexpensive, portable, and easy to use spectrometers, that they may be used by people in all disciplines and in all working conditions. For example, a small, simple spectrometer could form the basis of a personal UV exposure monitoring device.

Portable, inexpensive devices—such as cameras—exist that measure light intensity at different wavelengths simultaneously, but the spectral resolution of the different wavelengths is extremely low, so low that such devices are not thought of as spectrometers. Typical laboratory grade spectrophotometers might have a spectral resolution on the order of 1-10 nm. Depending on the application, lower resolution may be acceptable. In many cases, the higher the resolution requirement, the more expensive the instrument will be.

Spectrometers that overcome such challenges can be based on the physical and optical properties of nanocrystals. Nanocrystals having small diameters can have properties intermediate between molecular and bulk forms of matter. For example, nanocrystals based on semiconductor materials having small diameters can exhibit quantum confinement of both the electron and hole in all three dimensions, which leads to an increase in the effective band gap of the material with decreasing crystallite size. Consequently, both the optical absorption and emission of nanocrystals shift to the blue, or to higher energies, as the size of the crystallites decreases. When a semiconductor nanocrystal absorbs a photon, an excited electron-hole pair results. In some cases, when the electron-hole pair recombines, the semiconductor nanocrystal emits a photon (photoluminesces) at a longer wavelength.

In general, the absorption spectrum of a semiconductor nanocrystal features a prominent peak at a wavelength related to the effective band gap of the quantum confined semiconductor material. The band gap is a function of the size, shape, material, and configuration of the nanocrystal. Absorption of photons and the band gap wavelength can lead to emission of photons in a narrow spectral range; in other words, the photoluminescence spectrum can have a narrow full width at half maximum (FWHM). The absorption spectrum of the semiconductor nanocrystal also displays a strong, broad absorption feature extending to energies higher (into the UV) than the band gap.

A variety of optical effects can also be used to help increase the variety, these effects may include but not limited to absorption, transmission, reflectance, light scattering, ˜d enhancement, interference, plasmonic effects, quenching effects. These effects may be coupled with all the above mentioned materials or a subset of them. These effects may be used individually or collectively, in whole, or in part. In a nanocrystal spectrometer, it is unnecessary to include a prism, grating, or other optical element to separate light into component wavelengths. Rather, nanocrystals that respond to different wavelengths are used in photodetectors to measure the intensity of corresponding wavelengths. All the nanocrystals in the device can be illuminated with the full spectrum of incoming light, because each nanocrystal will respond only to a particular narrow range of wavelengths. When many photodetectors with different response profiles are used together, e.g., in a photodetector array, information about light intensities of different wavelengths or wavelength regions can be collected.

To diversify the nanocrystal structures, for example, by making each structure modify the same light differently, so that the light comes out of these structures are structure dependent, one can vary the nanocrystal materials, shape, geometry, size, core-shell structure, and/or chemically modify the surfaces, doping the structures, vary the thickness of the film, concentration of the material, add other materials that may or may not interact with nanocrystals but will modify the resulted light in some way, and/or with any other absorption and emission modification methods. The structures can be pre-assembled together first and then assembled to detectors, or be assembled directly onto detectors. The materials can be made into a thin film, either with the materials standing alone by themselves, or embedded in some encapsulating materials such as a polymer.

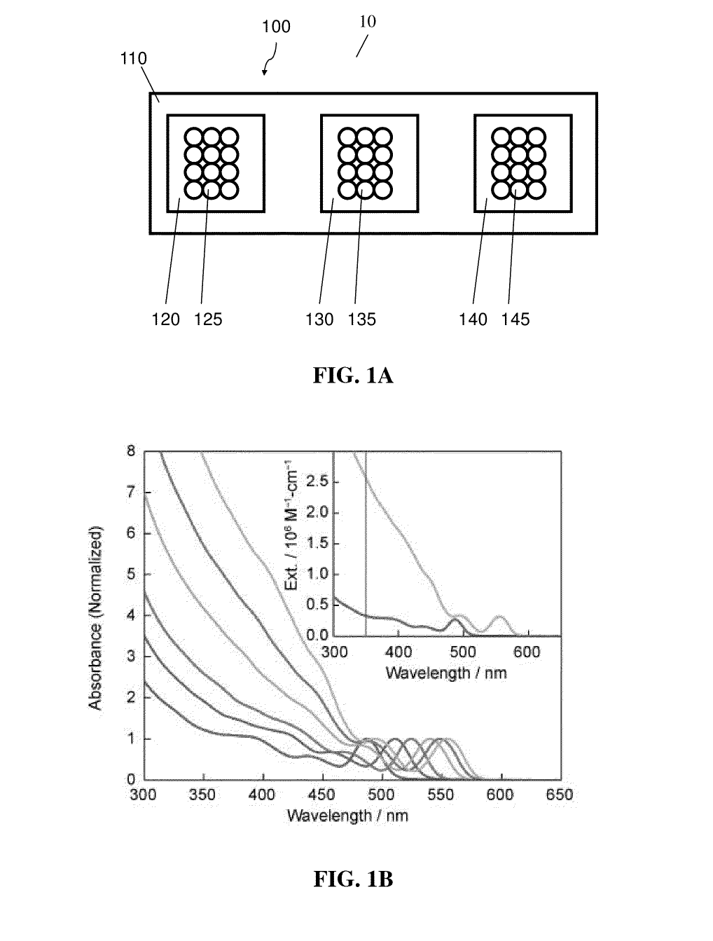

With regard to FIG. 1A, device 10 includes spectrometer 100 which includes housing 110 and photodetectors 120, 130, and 140. First photodetector 120 includes a first plurality of nanocrystals 125, which are responsive to a first wavelength of light. Second photodetector 130 includes a second plurality of nanocrystals 135, which are responsive to a second wavelength of light. Third photodetector 140 includes a third plurality of nanocrystals 145, which are responsive to a third wavelength of light. In this regard “responsive to a wavelength of light” can refer to the wavelength at which a plurality of nanocrystals has a peak responsiveness. For example, it can refer to the wavelength at which the plurality shows a characteristic band gap absorption feature in an absorption spectrum.

At least two of the first, second, and third wavelengths of light are distinct from one another. In some cases, a plurality of nanocrystals can be responsive to a range of wavelengths of light. As discussed above, nanocrystals typically have a characteristic band gap absorption feature and a broader, higher energy absorption feature. Two populations of nanocrystals can have distinct band gap absorption wavelengths yet have significant overlap in the wavelengths of the broader, higher energy absorption feature. Thus first plurality 125 and second plurality 135 can be responsive to wavelength ranges that overlap. In some embodiments, first plurality 125 and second plurality 135 can be responsive to wavelength ranges that do not overlap.

Even when two populations of semiconductor nanocrystals absorb light at overlapping wavelengths, the responsiveness of different populations can differ at a given wavelength. In particular, the absorption coefficient at a given wavelength can be different for different populations. In this respect, see FIG. 1B, showing exemplary spectra of different populations of semiconductor nanocrystals, illustrating how broad, high energy absorption features (in FIG. 1B, below about 450 nm) differ in extinction coefficients. In particular, the inset illustrates two populations where the extinction coefficients at 350 differ by about a factor of 5.

Spectrometer 100 can include additional photodetectors. The additional photodetectors can be duplicative of photodetectors 120, 130, or 140 (i.e., responsive to the same wavelength or range of wavelengths of light) or different from photodetectors 120, 130, or 140 (i.e., responsive to a different wavelength or range of wavelengths (e.g., an overlapping range of wavelengths) of light).

The spectrometer can be calibrated using one or more computational algorithms which account for various conditions and factors during data collection. One important role of the algorithms is to deconvolute the responses of different photodetectors. In one exemplary embodiment, a spectrometer includes a first photodetector which is responsive to wavelengths of 500 nm and shorter, and a second photodetector which is responsive to wavelengths of 450 nm and shorter. Consider the case where this spectrometer is illuminated simultaneously with 400 nm and 500 nm light. The signal from the first photodetector includes contributions from the response to both wavelengths in the incident light. The signal from the second photodetector also includes contributions from the response to only the 400 nm light. Thus the intensity of the incident 400 nm light can be determined directly from the response of the second photodetector. The intensity of the incident 500 nm light can be determined by first determining the intensity of the incident 400 nm light, and correcting the response of the first photodetector based on the contribution of incident 400 nm light to the response of the first photodetector (e.g., subtracting the response to 400 nm light).

The algorithm works in a similar fashion for larger numbers of photodetectors responsive to a greater number of overlapping wavelength ranges. The intensity at narrow wavelength ranges can be determined, narrower than the absorption profile of a given population of nanocrystals. The more photodetectors responsive to different, overlapping wavelength ranges, the higher the wavelength resolution (analogous to spectral resolution in a conventional grating-based spectrometer) that can be achieved.

Other conditions and factors that the algorithms can account for include but are not limited to: photodetector response profile (e.g., how efficiently light is converted to detector signal at different wavelengths); the number of nanocrystals present in a particular photodetector; the absorption, emission, quantum yield, and/or external quantum efficiency (EQE) profile of different nanocrystals; and various errors and/or losses. The wavelength resolution increases as the number of detectors with different nanocrystals increases.

A number of photodetector configurations can be used to make a nanocrystal spectrometer. Among the possible configurations are photovoltaics; photoconductors; a down-conversion configuration; or a filtering configuration. Each of these is described in turn. In general, by arranging nanocrystals proximal to and/or within the active layer of a photodetector the nanocrystals modulate the incident light profile. Some or all of the incoming photons can be absorbed by the nanocrystals, depending on the absorption profile of the nanocrystals and intensity profile of the incident light. Thus, individual photodetectors in the spectrometer can respond differently to different wavelength ranges of incident light.

In a photovoltaics configuration, each photodetector can include a photovoltaic cell in which semiconductor nanocrystals act as the active layer and central detector component. A photocurrent is generated when light of appropriate wavelength is absorbed by the photovoltaic cell. Only photons with an energy higher than the effective band gap of the nanocrystals will result in a photocurrent. Therefore, the intensity of the photocurrent increases with the intensity of incident light having an energy higher than the band gap increases. The photocurrent for each photodetector is amplified and analyzed to produce an output. Alternatively, measurement can be based on the photovoltage occurring at the photovoltaic cells instead of the photocurrent. See, for example, WO 2009/002305, which is incorporated by reference in its entirety.

The photovoltaic cells can include populations of nanocrystals responsive to different, overlapping wavelength ranges. The photovoltaic response (e.g., photocurrent or photovoltage) of the different photovoltaic cells will differ according to variations in intensity of incident light across the spectrum. As described above, from these differing responses, an algorithm can deconvolute the intensity of different wavelength ranges of incident light.

A photovoltaic device can include two layers separating two electrodes of the device. The material of one layer can be chosen based on the material's ability to transport holes, or the hole transporting layer (HTL). The material of the other layer can be chosen based on the material's ability to transport electrons, or the electron transporting layer (ETL). The electron transporting layer typically can include an absorptive layer. When a voltage is applied and the device is illuminated, one electrode accepts holes (positive charge carriers) from the hole transporting layer, while the other electrode accepts electrons from the electron transporting layer; the holes and electrons originate as excitons in the absorptive material. The device can include an absorptive layer between the HTL and the ETL. The absorptive layer can include a material selected for its absorption properties, such as absorption wavelength or linewidth.

A photovoltaic device can have a structure such as shown in FIG. 2, in which a first electrode 2, a first layer 3 in contact with the electrode 2, a second layer 4 in contact with the layer 3, and a second electrode 5 in contact with the second layer 4. First layer 3 can be a hole transporting layer and second layer 4 can be an electron transporting layer. At least one layer can be non-polymeric. The layers can include an inorganic material. One of the electrodes of the structure is in contact with a substrate 1. Each electrode can contact a power supply to provide a voltage across the structure. Photocurrent can be produced by the absorptive layer when a voltage of proper polarity and magnitude is applied across the device. First layer 3 can include a plurality of semiconductor nanocrystals, for example, a substantially monodisperse population of nanocrystals.

A substantially monodisperse population of nanocrystals can have a single characteristic band gap absorption wavelength. In some embodiments, one or more populations of nanocrystals (e.g., of different sizes, different materials, or both) can be combined to produce a resulting population having a different absorption profile than either population would separately.

Alternatively, a separate absorptive layer (not shown in FIG. 2) can be included between the hole transporting layer and the electron transporting layer. The separate absorptive layer can include the plurality of nanocrystals. A layer that includes nanocrystals can be a monolayer, of nanocrystals, or a multilayer of nanocrystals. In some instances, a layer including nanocrystals can be an incomplete layer, i.e., a layer having regions devoid of material such that layers adjacent to the nanocrystal layer can be in partial contact. The nanocrystals and at least one electrode have a band gap offset sufficient to transfer a charge carrier from the nanocrystals to the first electrode or the second electrode. The charge carrier can be a hole or an electron. The ability of the electrode to transfer a charge carrier permits the photoinduced current to flow in a manner that facilitates photodetection.

In some embodiments, the photovoltaic device can have a simple Schottky structure, e.g., having two electrodes and an active region including nanocrystals, without any HTL or ETL. In other embodiments, nanocrystals can be blended with the HTL material and/or with the ETL material to afford a bulk heterojunction device structure.

Photovoltaic devices including semiconductor nanocrystals can be made by spin-casting, drop-casting, dip-coating, spray-coating, or other methods to apply semiconductor nanocrystals to a surface. The method of deposition can be selected according to the needs of the application; for example, spin casting may be preferred for larger devices, while a masking technique or a printing method might be preferred for making smaller devices. In particular, a solution containing the HTL organic semiconductor molecules and the semiconductor nanocrystals can be spin-cast, where the HTL formed underneath of the semiconductor nanocrystal monolayer via phase separation (see, for example, U.S. Pat. Nos. 7,332,211, and 7,700,200, each of which is incorporated by reference in its entirety). This phase separation technique reproducibly placed a monolayer of semiconductor nanocrystals between an organic semiconductor HTL and ETL, thereby effectively exploiting the favorable light absorption properties of semiconductor nanocrystals, while minimizing their impact on electrical performance. Devices made by this technique were limited by impurities in the solvent, by the necessity to use organic semiconductor molecules that are soluble in the same solvents as the semiconductor nanocrystals. The phase separation technique was unsuitable for depositing a monolayer of semiconductor nanocrystals on top of both a HTL and a HIL (due to the solvent destroying the underlying organic thin film). Nor did the phase separation method allow control of the location of semiconductor nanocrystals that emit different colors on the same substrate; nor patterning of the different color emitting nanocrystals on that same substrate.

Moreover, the organic materials used in the transport layers (i.e., hole transport, hole injection, or electron transport layers) can be less stable than the semiconductor nanocrystals used in the absorptive layer. As a result, the operational life of the organic materials limits the life of the device. A device with longer-lived materials in the transport layers can be used to form a longer-lasting light emitting device.

The substrate can be opaque or transparent. A transparent substrate can be used to in the manufacture of a transparent device. See, for example, Bulovic, V. et al., Nature 1996, 380, 29; and Gu, G. et al., Appl. Phys. Lett. 1996, 68, 2606-2608, each of which is incorporated by reference in its entirety. The substrate can be rigid or flexible. The substrate can be plastic, metal or glass. The first electrode can be, for example, a high work function hole-injecting conductor, such as an indium tin oxide (ITO) layer. Other first electrode materials can include gallium indium tin oxide, zinc indium tin oxide, titanium nitride, or polyaniline. The second electrode can be, for example, a low work function (e.g., less than 4.0 eV), electron-injecting, metal, such as Al, Ba, Yb, Ca, a lithium-aluminum alloy (Li:Al), or a magnesium-silver alloy (Mg:Ag). The second electrode, such as Mg:Ag, can be covered with an opaque protective metal layer, for example, a layer of Ag for protecting the cathode layer from atmospheric oxidation, or a relatively thin layer of substantially transparent ITO. The first electrode can have a thickness of about 500 Angstroms to 4000 Angstroms. The first layer can have a thickness of about 50 Angstroms to about 5 micrometers, such as a thickness in the range of 100 Angstroms to 100 nm, 100 nm to 1 micrometer, or 1 micrometer to 5 micrometers. The second layer can have a thickness of about 50 Angstroms to about 5 micrometers, such as a thickness in the range of 100 Angstroms to 100 nm, 100 nm to 1 micrometer, or 1 micrometer to 5 micrometers. The second electrode can have a thickness of about 50 Angstroms to greater than about 1000 Angstroms.

A hole transporting layer (HTL) or an electron transporting layer (ETL) can include an inorganic material, such as an inorganic semiconductor. The inorganic semiconductor can be any material with a band gap greater than the emission energy of the emissive material. The inorganic semiconductor can include a metal chalcogenide, metal pnictide, or elemental semiconductor, such as a metal oxide, a metal sulfide, a metal selenide, a metal telluride, a metal nitride, a metal phosphide, a metal arsenide, or metal arsenide. For example, the inorganic material can include zinc oxide, a titanium oxide, a niobium oxide, an indium tin oxide, copper oxide, nickel oxide, vanadium oxide, chromium oxide, indium oxide, tin oxide, gallium oxide, manganese oxide, iron oxide, cobalt oxide, aluminum oxide, thallium oxide, silicon oxide, germanium oxide, lead oxide, zirconium oxide, molybdenum oxide, hafnium oxide, tantalum oxide, tungsten oxide, cadmium oxide, iridium oxide, rhodium oxide, ruthenium oxide, osmium oxide, a zinc sulfide, zinc selenide, zinc telluride, cadmium sulfide, cadmium selenide, cadmium telluride, mercury sulfide, mercury selenide, mercury telluride, silicon carbide, diamond (carbon), silicon, germanium, aluminum nitride, aluminum phosphide, aluminum arsenide, aluminum antimonide, gallium nitride, gallium phosphide, gallium arsenide, gallium antimonide, indium nitride, indium phosphide, indium arsenide, indium antimonide, thallium nitride, thallium phosphide, thallium arsenide, thallium antimonide, lead sulfide, lead selenide, lead telluride, iron sulfide, indium selenide, indium sulfide, indium telluride, gallium sulfide, gallium selenide, gallium telluride, tin selenide, tin telluride, tin sulfide, magnesium sulfide, magnesium selenide, magnesium telluride, or a mixture thereof. The metal oxide can be a mixed metal oxide, such as, for example, ITO. In a device, a layer of pure metal oxide (i.e., a metal oxide with a single substantially pure metal) can develop crystalline regions over time degrading the performance of the device. A mixed metal oxide can be less prone to forming such crystalline regions, providing longer device lifetimes than available with pure metal oxides. The metal oxide can be a doped metal oxide, where the doping is, for example, an oxygen deficiency, a halogen dopant, or a mixed metal. The inorganic semiconductor can include a dopant. In general, the dopant can be a p-type or an n-type dopant. An HTL can include a p-type dopant, whereas an ETL can include an n-type dopant.

Single crystalline inorganic semiconductors have been proposed for charge transport to semiconductor nanocrystals in devices. Single crystalline inorganic semiconductors are deposited by techniques that require heating the substrate to be coated to a high temperature. However, the top layer semiconductors must be deposited directly onto the nanocrystal layer, which is not robust to high temperature processes, nor suitable for facile epitaxial growth. Epitaxial techniques (such as chemical vapor deposition) can also be costly to manufacture, and generally cannot be used to cover a large area, (i.e., larger than a 12 inch diameter wafer).

Advantageously, the inorganic semiconductor can be deposited on a substrate at a low temperature, for example, by sputtering. Sputtering is performed by applying a high voltage across a low-pressure gas (for example, argon) to create a plasma of electrons and gas ions in a high-energy state. Energized plasma ions strike a target of the desired coating material, causing atoms from that target to be ejected with enough energy to travel to, and bond with, the substrate.

The substrate or the device being manufactured is cooled or heated for temperature control during the growth process. The temperature affects the crystallinity of the deposited material as well as how it interacts with the surface it is being deposited upon. The deposited material can be polycrystalline or amorphous. The deposited material can have crystalline domains with a size in the range of 10 Angstroms to 1 micrometer. Doping concentration can be controlled by varying the gas, or mixture of gases, which is used for the sputtering plasma. The nature and extent of doping can influence the conductivity of the deposited film, as well as its ability to optically quench neighboring excitons. By growing one material on top of another, p-n or p-i-n diodes can be created. The device can be optimized for delivery of charge to a semiconductor nanocrystal monolayer.

The layers can be deposited on a surface of one of the electrodes by spin coating, dip coating, vapor deposition, sputtering, or other thin film deposition methods. The second electrode can be sandwiched, sputtered, or evaporated onto the exposed surface of the solid layer. One or both of the electrodes can be patterned. The electrodes of the device can be connected to a voltage source by electrically conductive pathways. Upon application of the voltage, light is generated from the device.

Microcontact printing provides a method for applying a material to a predefined region on a substrate. The predefined region is a region on the substrate where the material is selectively applied. The material and substrate can be chosen such that the material remains substantially entirely within the predetermined area. By selecting a predefined region that forms a pattern, material can be applied to the substrate such that the material forms a pattern. The pattern can be a regular pattern (such as an array, or a series of lines), or an irregular pattern. Once a pattern of material is formed on the substrate, the substrate can have a region including the material (the predefined region) and a region substantially free of material. In some circumstances, the material forms a monolayer on the substrate. The predefined region can be a discontinuous region. In other words, when the material is applied to the predefined region of the substrate, locations including the material can be separated by other locations that are substantially free of the material.

In general, microcontact printing begins by forming a patterned mold. The mold has a surface with a pattern of elevations and depressions. A stamp is formed with a complementary pattern of elevations and depressions, for example by coating the patterned surface of the mold with a liquid polymer precursor that is cured while in contact with the patterned mold surface. The stamp can then be inked; that is, the stamp is contacted with a material which is to be deposited on a substrate. The material becomes reversibly adhered to the stamp. The inked stamp is then contacted with the substrate. The elevated regions of the stamp can contact the substrate while the depressed regions of the stamp can be separated from the substrate. Where the inked stamp contacts the substrate, the ink material (or at least a portion thereof) is transferred from the stamp to the substrate. In this way, the pattern of elevations and depressions is transferred from the stamp to the substrate as regions including the material and free of the material on the substrate. Microcontact printing and related techniques are described in, for example, U.S. Pat. Nos. 5,512,131; 6,180,239; and 6,518,168, each of which is incorporated by reference in its entirety. In some circumstances, the stamp can be a featureless stamp having a pattern of ink, where the pattern is formed when the ink is applied to the stamp. See U.S. Patent Application Publication No. 2006/0196375, which is incorporated by reference in its entirety. Additionally, the ink can be treated (e.g., chemically or thermally) prior to transferring the ink from the stamp to the substrate. In this way, the patterned ink can be exposed to conditions that are incompatible with the substrate.

Individual devices can be formed at multiple locations on a single substrate to form a photovoltaic array. In some applications, the substrate can include a backplane. The backplane includes active or passive electronics for controlling or switching power to or from individual array elements. Including a backplane can be useful for applications such as displays, sensors, or imagers. In particular, the backplane can be configured as an active matrix, passive matrix, fixed format, directly drive, or hybrid. See U.S. Patent Application Publication No. 2006/0196375, which is incorporated by reference in its entirety.

To form a device, a p-type semiconductor such as, for example, NiO can be deposited on a transparent electrode such as indium time oxide (ITO). The transparent electrode can be arranged on a transparent substrate. Then, semiconductor nanocrystals are deposited using a large-area compatible, single monolayer deposition technique such as micro-contact printing or a Langmuir-Blodgett (LB) technique. Subsequently, an n-type semiconductor (e.g., ZnO or TiO₂) is applied, for example by sputtering, on top of this layer. A metal or semiconductor electrode can be applied over this to complete the device. More complicated device structures are also possible. For example, a lightly doped layer can be included proximal to the nanocrystal layer.

The device can be assembled by separately growing the two transport layers, and physically applying the electrical contacts using an elastomer such as polydimethylsiloxane (PDMS). This avoids the need for direct deposition of material on the nanocrystal layer.

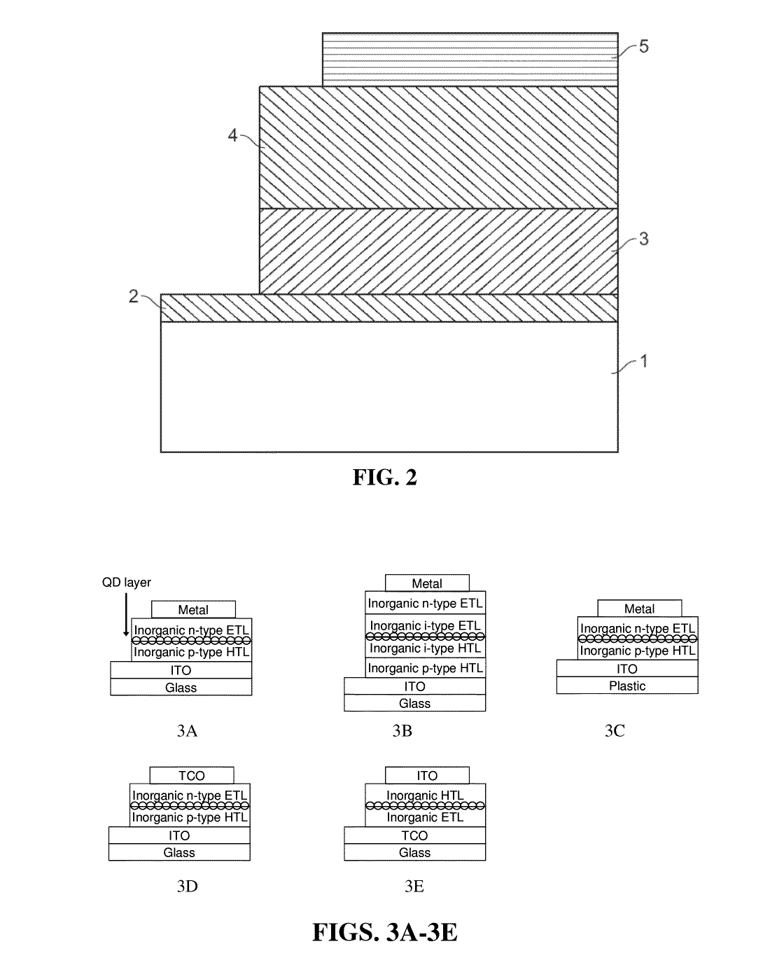

The device can be thermally treated after application of all of the transport layers. The thermal treatment can further enhance separation of charges from the nanocrystals, as well as eliminate the organic capping groups on the nanocrystals. The instability of the capping groups can contribute to device instability. FIGS. 3A-3E show possible device structures. They are a standard p-n diode design (FIG. 3A), a p-i-n diode design (FIG. 3B), a transparent device (FIG. 3C), an inverted device (FIG. 3D), and a flexible device (FIG. 3E). In the case of the flexible device, it is possible to incorporate slippage layers, i.e. metal oxide/metal/metal oxide type three layer structures, for each single layer metal oxide layer. This has been shown to increase the flexibility of metal oxide thin films, increasing conductivity, while maintaining transparency. This is because the metal layers, typically silver, are very thin (roughly 12 nm each) and therefore do not absorb much light.

In a photoconductor configuration, the nanocrystal itself is the active layer and central detector component. When photons having an energy higher than the nanocrystal band gap, excitons are formed and undergo charge separation. The separated charge carriers increase the conductivity of the nanocrystal layer(s). By applying a voltage across the nanocrystal layer(s), the conductivity of the device can be measured. The conductivity increases with the number of photons having an energy above the nanocrystal band gap absorbed by the photoconductor. See, for example, US Patent Application Publication No. 2010/0025595, which is incorporated by reference in its entirety.

The photoconductors cells can include populations of nanocrystals responsive to different, overlapping wavelength ranges. The photoconductive response of the different photoconductors will differ according to variations in intensity of incident light across the spectrum. As described above, from these differing responses, an algorithm can deconvolute the intensity of different wavelength ranges of incident light.

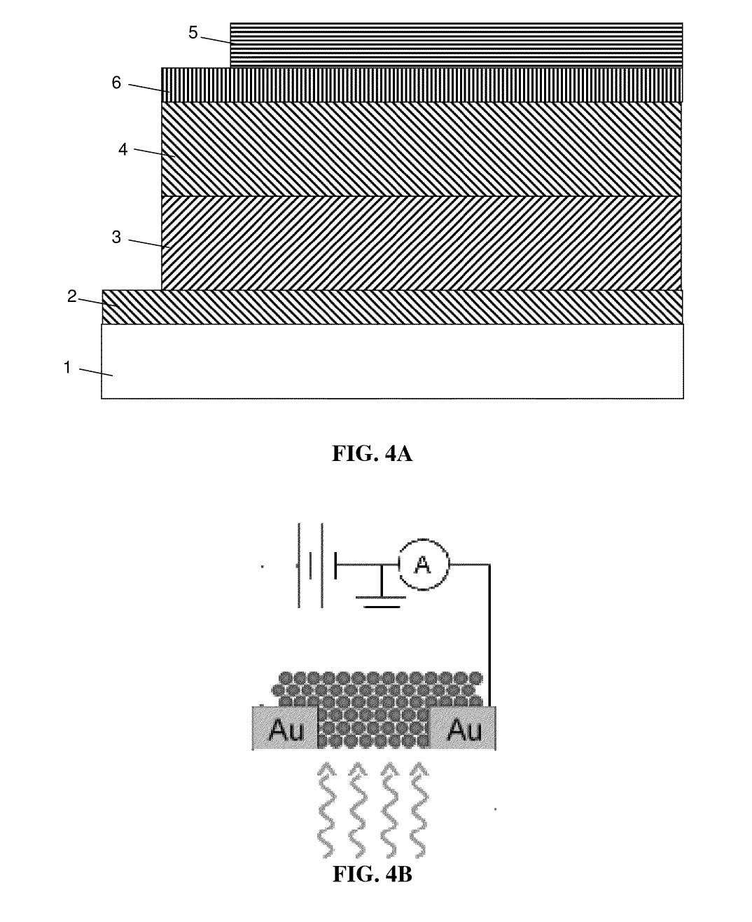

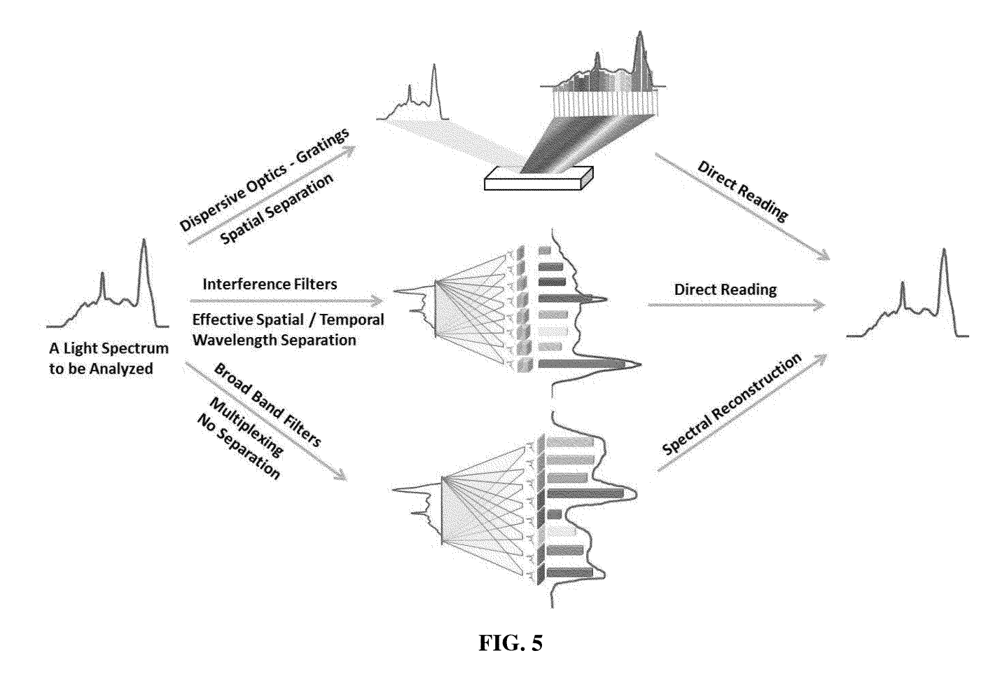

A electro-optical device can have a structure such as shown in FIG. 2 or FIG. 4A, in which a first electrode 2, a first layer 3 in contact with the electrode 2, a second layer 4 in contact with the first layer 3, and a second electrode 5 in contact with the second layer 4. First layer 3 can be a hole transporting layer and second layer 4 can be an electron transporting layer. At least one layer can be non-polymeric. The layers can include an organic or an inorganic material. One of the electrodes of the structure is in contact with a substrate 1. Each electrode can contact a power supply to provide a voltage across the structure. Photocurrent (i.e., electrical current generated in response to absorption of radiation) can be produced by the device when a voltage of proper polarity and magnitude is applied across the layers, and light of appropriate wavelength illuminates the device. Second layer 4 can include a plurality of semiconductor nanocrystals, for example, a substantially monodisperse population of nanocrystals. Optionally, an electron transport layer 6 is located intermediate electrode 5 and second layer 4 (see FIG. 4A).

Alternatively, a separate absorptive layer (not shown in FIG. 2) can be included between the hole transporting layer and the electron transporting layer. The separate absorptive layer can include the plurality of nanocrystals. A layer that includes nanocrystals can be a monolayer, of nanocrystals, or a multilayer of nanocrystals. In some instances, a layer including nanocrystals can be an incomplete layer, i.e., a layer having regions devoid of material such that layers adjacent to the nanocrystal layer can be in partial contact. The nanocrystals and at least one electrode have a band gap offset sufficient to transfer a charge carrier from the nanocrystals to the first electrode or the second electrode. The charge carrier can be a hole or an electron. The ability of the electrode to transfer a charge carrier permits the photoinduced current to flow in a manner that facilitates photodetection.

In other embodiments, the photoconductor can have a planar structure as illustrated in FIG. 4B, having two electrodes separated by an active region including semiconductor nanocrystals. Likewise, the device can omit HTL and/or ETL materials, and include simply two electrodes and an active region including semiconductor nanocrystals. In other embodiments, nanocrystals can be blended with the HTL material and/or with the ETL material

The substrate can be opaque or transparent. The substrate can be rigid or flexible. The first electrode can have a thickness of about 500 Angstroms to 4000 Angstroms. The first layer can have a thickness of about 50 Angstroms to about 5 micrometers, such as a thickness in the range of 100 Angstroms to 100 nm, 100 nm to 1 micrometer, or 1 micrometer to 5 micrometers. The second layer can have a thickness of about 50 Angstroms to about 5 micrometers, such as a thickness in the range of 100 Angstroms to 100 nm, 100 nm to 1 micrometer, or 1 micrometer to 5 micrometers. The second electrode can have a thickness of about 50 Angstroms to greater than about 1000 Angstroms. Each of the electrodes can be a metal, for example, copper, aluminum, silver, gold or platinum, or combination thereof, a doped oxide, such as an indium oxide or tin oxide, or a semiconductor, such as a doped semiconductor, for example, p-doped silicon.

The electron transporting layer (ETL) can be a molecular matrix. The molecular matrix can be non-polymeric. The molecular matrix can include a small molecule, for example, a metal complex. For example, the metal complex can be a metal complex of 8-hydroxyquinoline. The metal complex of 8-hydroxyquinoline can be an aluminum, gallium, indium, zinc or magnesium complex, for example, aluminum tris(8-hydroxyquinoline) (Alq₃). Other classes of materials in the ETL can include metal thioxinoid compounds, oxadiazole metal chelates, triazoles, sexithiophene derivatives, pyrazine, and styrylanthracene derivatives. The hole transporting layer can include an organic chromophore. The organic chromophore can be a phenyl amine, such as, for example, N,N′-diphenyl-N,N-bis(3-methylphenyl)-(1,1′-biphenyl)-4,4′-diamine (TPD). The HTL can include a polyaniline, a polypyrrole, a poly(phenylene vinylene), copper phthalocyanine, an aromatic tertiary amine or polynucluear aromatic tertiary amine, a 4,4′-bis(9-carbazolyl)-1,1′-biphenyl compound, or an N,N,N′,N′-tetraarylbenzidine. In some cases, the HTL can include more than one hole transporting material, which can be commingled or in distinct layers.

In some embodiments, the device can be prepared without a separate electron transporting layer. In such a device, an absorptive layer which can include semiconductor nanocrystals is adjacent to an electrode. The electrode adjacent to the absorptive layer can advantageously be a semiconductor material that is also sufficiently conductive to be useful as an electrode. Indium tin oxide (ITO) is one suitable material.

The device can be made in a controlled (oxygen-free and moisture-free) environment, which can help maintain the integrity of device materials during the fabrication process. Other multilayer structures may be used to improve the device performance (see, for example, U.S. Patent Application Publication Nos. 2004/0023010 and 2007/0103068, each of which is incorporated by reference in its entirety). A blocking layer, such as an electron blocking layer (EBL), a hole blocking layer (HBL) or a hole and electron blocking layer (eBL), can be introduced in the structure. A blocking layer can include 3-(4-biphenylyl)-4-phenyl-5-tert-butylphenyl-1,2,4-triazole (TAZ), 3,4,5-triphenyl-1,2,4-triazole, 3,5-bis(4-tert-butylphenyl)-4-phenyl-1,2,4-triazo, bathocuproine (BCP), 4,4′,4″-tris{N-(3-methylphenyl)-N-phenylamino}triphenylamine (m-MTDATA), polyethylene dioxythiophene (PEDOT), 1,3-bis(5-(4-diphenylamino)phenyl-1,3,4-oxadiazol-2-yl)benzene, 2-(4-biphenylyl)-5-(4-tert-butylphenyl)-1,3,4-oxadiazole, 1,3-bis[5-(4-(1,1-dimethylethyl)phenyl)-1,3,4-oxadiazol-2-yl]benzene, 1,4-bis(5-(4-diphenylamino)phenyl-1,3,4-oxadiazol-2-yl)benzene, or 1,3,5-tris[5-(4-(1,1-dimethylethyl)phenyl)-1,3,4-oxadiazol-2-yl]benzene.

In a downconversion configuration, the nanocrystal is not the central conversion component, but is an important component in modulating the incident light profile. As discussed above, a semiconductor nanocrystal absorbs light at a particular wavelength and can subsequently emit light of a longer wavelength. The emission is at a characteristic wavelength for the size and composition of the nanocrystal, and depending on the nature of nanocrystal population, can have a narrow FWHM.

By arranging nanocrystals proximal to the active layer of a photodetector (e.g., a photodetector which can respond to a broad range of wavelengths), the nanocrystals modulate the incident light profile. Some or all of the incoming photons can be absorbed by the nanocrystals (depending on the absorption profile of the nanocrystals and intensity profile of the incident light), and emitted at the characteristic wavelength before reaching the photodetector. In this way, the photons incident upon the photodetector have a different wavelength profile than the photons incident on the device generally. Different nanocrystals can produce different resulting profiles given the same incident photons. See, for example, WO 2007/136816, which is incorporated by reference in its entirety.

The device, in a downconversion configuration, can have a pixel structure as follows: a thin layer of nanocrystals are arranged on top of a transparent side of a conventional detector pixel. Incident photons (e.g., UV photons) are absorbed by the nanocrystals, which emit a longer wavelength (downconverted wavelength) of light (e.g., a visible or IR wavelength). The intensity of emission is related to the intensity of the incident photons of an appropriate energy to be absorbed by the nanocrystals. (An important factor in the relation between incident and downconverted intensity is the quantum efficiency of the nanocrystals). The downconverted photons are detected by the conventional photodetector, and the intensity of the incident photons are measured.

The individual pixels of the device can be arranged on a conventional integrated circuit device; each pixel having nanocrystals which are responsive to a selected wavelength of light. By providing a plurality of pixels where different pixels have nanocrystals responsive to different wavelengths of light, the larger device can measure the intensity of incident photons across a desired portion of the electromagnetic spectrum, e.g., a desired portion of the spectrum within the UV, visible, or IR regions of the spectrum.

In a filtering configuration, the nanocrystal is not the central conversion component, but an important component in modulating the incident light profile. In this configuration, the nanocrystals are prepared in a manner such that light emission from the nanocrystals is suppressed. Absorption properties of the nanocrystals remain substantially unchanged. The device structure is similar to that in the downconversion configuration, but each pixel can have a thicker layer of nanocrystals than used in the downconversion configuration.

The nanocrystal layer absorbs a large proportion of the income nanocrystals at or above a particular energy. The energy level is dependent on the absorption profile of the nanocrystals and the thickness of the film. As in other configurations, different nanocrystals with different optical properties (here, different absorption profiles) can be deposited over different pixels. The nanocrystal films act like filters, filtering out different portions of the spectrum of the incident light. Thus the pixels can measure different portions of the spectrum.

Semiconductor nanocrystals demonstrate quantum confinement effects in their luminescence properties. When semiconductor nanocrystals are illuminated with a primary energy source, a secondary emission of energy occurs at a frequency related to the band gap of the semiconductor material used in the nanocrystal. In quantum confined particles, the frequency is also related to the size of the nanocrystal.

The semiconductor forming the nanocrystals can include a Group II-VI compound, a Group II-V compound, a Group III-VI compound, a Group III-V compound, a Group IV-VI compound, a Group compound, a Group II-IV-VI compound, or a Group II-IV-V compound, for example, ZnO, ZnS, ZnSe, ZnTe, CdO, CdS, CdSe, CdTe, MgO, MgS, MgSe, MgTe, HgO, HgS, HgSe, HgTe, AlN, AlP, AlAs, AlSb, GaN, GaP, GaAs, GaSb, InN, InP, InAs, InSb, TlN, TlP, TlAs, TlSb, TlSb, PbS, PbSe, PbTe, Cd₃As₂, Cd₃P₂ or mixtures thereof.

In general, the method of manufacturing a nanocrystal is a colloidal growth process. See, for example, U.S. Pat. Nos. 6,322,901, 6,576,291, and 7,253,452, and U.S. patent application Ser. No. 12/862,195, filed Aug. 24, 2010, each of which is incorporated by reference in its entirety. Colloidal growth can result when an M-containing compound and an X donor are rapidly injected into a hot coordinating solvent. The coordinating solvent can include an amine. The M-containing compound can be a metal, an M-containing salt, or an M-containing organometallic compound. The injection produces a nucleus that can be grown in a controlled manner to form a nanocrystal. The reaction mixture can be gently heated to grow and anneal the nanocrystal. Both the average size and the size distribution of the nanocrystals in a sample are dependent on the growth temperature. In some circumstances, the growth temperature necessary to maintain steady growth increases with increasing average crystal size. The nanocrystal is a member of a population of nanocrystals. As a result of the discrete nucleation and controlled growth, the population of nanocrystals obtained has a narrow, monodisperse distribution of diameters. The monodisperse distribution of diameters can also be referred to as a size. The process of controlled growth and annealing of the nanocrystals in the coordinating solvent that follows nucleation can also result in uniform surface derivatization and regular core structures. As the size distribution sharpens, the temperature can be raised to maintain steady growth. By adding more M-containing compound or X donor, the growth period can be shortened. When adding more M-containing compound or X donor after the initial injection, the addition can be relatively slow, e.g., in several discrete portions added at intervals, or a slow continuous addition. Introducing can include heating a composition including the coordinating solvent and the M-containing compound, rapidly adding a first portion of the X donor to the composition, and slowly adding a second portion of the X donor. Slowly adding the second portion can include a substantially continuous slow addition of the second portion. See, for example, U.S. patent application Ser. No. 13/348,126 which was filed on Jan. 11, 2012, which is incorporated by reference in its entirety.

The M-containing salt can be a non-organometallic compound, e.g., a compound free of metal-carbon bonds. M can be cadmium, zinc, magnesium, mercury, aluminum, gallium, indium, thallium, or lead. The M-containing salt can be a metal halide, metal carboxylate, metal carbonate, metal hydroxide, metal oxide, or metal diketonate, such as a metal acetylacetonate. The M-containing salt is less expensive and safer to use than organometallic compounds, such as metal alkyls. For example, the M-containing salts are stable in air, whereas metal alkyls are generally unstable in air. M-containing salts such as 2,4-pentanedionate (i.e., acetylacetonate (acac)), halide, carboxylate, hydroxide, oxide, or carbonate salts are stable in air and allow nanocrystals to be manufactured under less rigorous conditions than corresponding metal alkyls. In some cases, the M-containing salt can be a long-chain carboxylate salt, e.g., a C₈ or higher (such as C₈ to C₂₀, or C₁₂ to C₁₈), straight chain or branched, saturated or unsaturated carboxylate salt. Such salts include, for example, M-containing salts of lauric acid, myristic acid, palmitic acid, stearic acid, arachidic acid, palmitoleic acid, oleic acid, linoleic acid, linolenic acid, or arachidonic acid.

Suitable M-containing salts include cadmium acetylacetonate, cadmium iodide, cadmium bromide, cadmium chloride, cadmium hydroxide, cadmium carbonate, cadmium acetate, cadmium myristate, cadmium oleate, cadmium oxide, zinc acetylacetonate, zinc iodide, zinc bromide, zinc chloride, zinc hydroxide, zinc carbonate, zinc acetate, zinc myristate, zinc oleate, zinc oxide, magnesium acetylacetonate, magnesium iodide, magnesium bromide, magnesium chloride, magnesium hydroxide, magnesium carbonate, magnesium acetate, magnesium myristate, magnesium oleate, magnesium oxide, mercury acetylacetonate, mercury iodide, mercury bromide, mercury chloride, mercury hydroxide, mercury carbonate, mercury acetate, mercury myristate, mercury oleate, aluminum acetylacetonate, aluminum iodide, aluminum bromide, aluminum chloride, aluminum hydroxide, aluminum carbonate, aluminum acetate, aluminum myristate, aluminum oleate, gallium acetylacetonate, gallium iodide, gallium bromide, gallium chloride, gallium hydroxide, gallium carbonate, gallium acetate, gallium myristate, gallium oleate, indium acetylacetonate, indium iodide, indium bromide, indium chloride, indium hydroxide, indium carbonate, indium acetate, indium myristate, indium oleate, thallium acetylacetonate, thallium iodide, thallium bromide, thallium chloride, thallium hydroxide, thallium carbonate, thallium acetate, thallium myristate, or thallium oleate.

Prior to combining the M-containing salt with the X donor, the M-containing salt can be contacted with a coordinating solvent to form an M-containing precursor. Typical coordinating solvents include alkyl phosphines, alkyl phosphine oxides, alkyl phosphonic acids, or alkyl phosphinic acids; however, other coordinating solvents, such as pyridines, furans, and amines may also be suitable for the nanocrystal production. Examples of suitable coordinating solvents include pyridine, tri-n-octyl phosphine (TOP) and tri-n-octyl phosphine oxide (TOPO). Technical grade TOPO can be used. The coordinating solvent can include a 1,2-diol or an aldehyde. The 1,2-diol or aldehyde can facilitate reaction between the M-containing salt and the X donor and improve the growth process and the quality of the nanocrystal obtained in the process. The 1,2-diol or aldehyde can be a C₆-C₂₀ 1,2-diol or a C₆-C₂₀ aldehyde. A suitable 1,2-diol is 1,2-hexadecanediol or myristol and a suitable aldehyde is dodecanal is myristic aldehyde.

The X donor is a compound capable of reacting with the M-containing salt to form a material with the general formula MX. Typically, the X donor is a chalcogenide donor or a pnictide donor, such as a phosphine chalcogenide, a bis(silyl)chalcogenide, dioxygen, an ammonium salt, or a tris(silyl)pnictide. Suitable X donors include dioxygen, elemental sulfur, bis(trimethylsilyl)selenide ((TMS)₂Se), trialkyl phosphine selenides such as (tri-n-octylphosphine) selenide (TOPSe) or (tri-n-butylphosphine) selenide (TBPSe), trialkyl phosphine tellurides such as (tri-n-octylphosphine) telluride (TOPTe) or hexapropylphosphorustriamide telluride (HPPTTe), bis(trimethylsilyl)telluride ((TMS)₂Te), sulfur, bis(trimethylsilyl)sulfide ((TMS)₂S), a trialkyl phosphine sulfide such as (tri-n-octylphosphine) sulfide (TOPS), tris(dimethylamino) arsine, an ammonium salt such as an ammonium halide (e.g., NH₄Cl), tris(trimethylsilyl)phosphide ((TMS)₃P), tris(trimethylsilyl) arsenide ((TMS)₃As), or tris(trimethylsilyl)antimonide ((TMS)₃Sb). In certain embodiments, the M donor and the X donor can be moieties within the same molecule.

The X donor can be a compound of formula (I):

X(Y(R)₃)₃ (I)

where X is a group V element, Y is a group IV element, and each R, independently, is alkyl, alkenyl, alkynyl, cycloalkyl, cycloalkenyl, heterocyclyl, aryl, or heteroaryl, where each R, independently, is optionally substituted by 1 to 6 substituents independently selected from hydrogen, halo, hydroxy, nitro, cyano, amino, alkyl, cycloalkyl, cycloalkenyl, alkoxy, acyl, thio, thioalkyl, alkenyl, alkynyl, cycloalkenyl, heterocyclyl, aryl, or heteroaryl. See, e.g., provisional U.S. Patent Application No. 61/535,597, filed Sep. 16, 2011, which is incorporated by reference in its entirety.

In some embodiments, X can be N, P, As, or Sb. Y can be C, Si, Ge, Sn, or Pb. Each R, independently, can be alkyl or cycloalkyl. In some cases, each R, independently, can be unsubstituted alkyl or unsubstituted cycloalkyl, for example, a C₁ to C₈ unsubstituted alkyl or a C₃ to C₈ unsubstituted cycloalkyl. In some embodiments, X can be P, As, or Sb. In some embodiments, Y can be Ge, Sn, or Pb.

In some embodiments, X can be P, As, or Sb, Y can be Ge, Sn, or Pb, and each R, independently, can be unsubstituted alkyl or unsubstituted cycloalkyl, for example, a C₁ to C₈ unsubstituted alkyl or a C₃ to C₈ unsubstituted cycloalkyl. Each R, independently, can be unsubstituted alkyl, for example, a C₁ to C₆ unsubstituted alkyl.

Alkyl is a branched or unbranched saturated hydrocarbon group of 1 to 30 carbon atoms, such as methyl, ethyl, n-propyl, isopropyl, n-butyl, isobutyl, t-butyl, octyl, decyl, tetradecyl, hexadecyl, eicosyl, tetracosyl and the like. Optionally, an alkyl group can be substituted by 1 to 6 substituents independently selected from hydrogen, halo, hydroxy, nitro, cyano, amino, alkyl, cycloalkyl, cycloalkenyl, alkoxy, acyl, thio, thioalkyl, alkenyl, alkynyl, cycloalkenyl, heterocyclyl, aryl, or heteroaryl. Optionally, an alkyl group can contain 1 to 6 linkages selected from —O—, —S—, -M- and —NR— where R is hydrogen, or C₁-C₈ alkyl or lower alkenyl. Cycloalkyl is a cyclic saturated hydrocarbon group of 3 to 10 carbon atoms, such as cyclopropyl, cyclobutyl, cyclopentyl, cyclohexyl, cycloheptyl, cyclooctyl, and the like. A cycloalkyl group can be optionally substituted, or contain linkages, as an alkyl group does.

Alkenyl is a branched or unbranched unsaturated hydrocarbon group of 2 to 20 carbon atoms containing at least one double bond, such as vinyl, propenyl, butenyl, and the like. Cycloalkenyl is a cyclic unsaturated hydrocarbon group of 3 to 10 carbon atoms including at least one double bond. An alkenyl or cycloalkenyl group can be optionally substituted, or contain linkages, as an alkyl group does.

Alkynyl is a branched or unbranched unsaturated hydrocarbon group of 2 to 20 carbon atoms containing at least one triple bond, such as ethynyl, propynyl, butynyl, and the like. An alkynyl group can be optionally substituted, or contain linkages, as an alkyl group does.

Heterocyclyl is a 3- to 10-membered saturated or unsaturated cyclic group including at least one ring heteroatom selected from O, N, or S. A heterocylyl group can be optionally substituted, or contain linkages, as an alkyl group does.

Aryl is a 6- to 14-membered carbocyclic aromatic group which may have one or more rings which may be fused or unfused. In some cases, an aryl group can include an aromatic ring fused to a non-aromatic ring. Exemplary aryl groups include phenyl, naphthyl, or anthracenyl. Heteroaryl is a 6- to 14-membered aromatic group which may have one or more rings which may be fused or unfused. In some cases, a heteroaryl group can include an aromatic ring fused to a non-aromatic ring. An aryl or heteroaryl group can be optionally substituted, or contain linkages, as an alkyl group does.

For given values of X and R, varying Y can produce X donors having varying reactivity, e.g., different reaction kinetics in the formation of semiconductor nanocrystals. Thus, the reactivity of tris(trimethylsilyl)arsine in the formation of nanocrystals can be different from the reactivity of tris(trimethylstannyl)arsine or tris(trimethylplumbyl)arsine in an otherwise similar reaction. Likewise, for given values of X and Y, variations in R can produce variations in reactivity. In the formation of nanocrystals, reactivity (and particularly reaction kinetics) can affect the size and size distribution of the resulting population of nanocrystals. Thus, selection of precursors having appropriate reactivity can aid in forming a population of nanocrystals having desirable properties, such as a particular desired size and/or a narrow size distribution.

Examples of X donors of formula (I) include: tris(trimethylgermyl)nitride, N(Ge(CH₃)₃)₃; tris(trimethylstannyl)nitride, N(Sn(CH₃)₃)₃; tris(trimethylplumbyl)nitride, N(Pb(CH₃)₃)₃; tris(trimethylgermyl)phosphide, P(Ge(CH₃)₃)₃; tris(trimethylstannyl)phosphide, P(Sn(CH₃)₃)₃; tris(trimethylplumbyl)phosphide, P(Pb(CH₃)₃)₃; tris(trimethylgermyl)arsine, As(Ge(CH₃)₃)₃; tris(trimethylstannyl)arsine, As(Sn(CH₃)₃)₃; tris(trimethylplumbyl)arsine, As(Pb(CH₃)₃)₃; tris(trimethylgermyl)stibine, Sb(Ge(CH₃)₃)₃; tris(trimethylstannyl)stibine, Sb(Sn(CH₃)₃)₃; and tris(trimethylplumbyl)stibine, Sb(Pb(CH₃)₃)₃.

A coordinating solvent can help control the growth of the nanocrystal. The coordinating solvent is a compound having a donor lone pair that, for example, has a lone electron pair available to coordinate to a surface of the growing nanocrystal. Solvent coordination can stabilize the growing nanocrystal. Typical coordinating solvents include alkyl phosphines, alkyl phosphine oxides, alkyl phosphonic acids, or alkyl phosphinic acids, however, other coordinating solvents, such as pyridines, furans, and amines may also be suitable for the nanocrystal production. Examples of suitable coordinating solvents include pyridine, tri-n-octyl phosphine (TOP), tri-n-octyl phosphine oxide (TOPO) and tris-hydroxylpropylphosphine (tHPP). Technical grade TOPO can be used.

The nanocrystal manufactured from an M-containing salt can grow in a controlled manner when the coordinating solvent includes an amine. The amine in the coordinating solvent can contribute to the quality of the nanocrystal obtained from the M-containing salt and X donor. The coordinating solvent can a mixture of the amine and an alkyl phosphine oxide. The combined solvent can decrease size dispersion and can improve photoluminescence quantum yield of the nanocrystal. The amine can be a primary alkyl amine or a primary alkenyl amine, such as a C2-C20 alkyl amine, a C2-C20 alkenyl amine, preferably a C8-C18 alkyl amine or a C8-C18 alkenyl amine. For example, suitable amines for combining with tri-octylphosphine oxide (TOPO) include 1-hexadecylamine, or oleylamine. When the 1,2-diol or aldehyde and the amine are used in combination with the M-containing salt to form a population of nanocrystals, the photoluminescence quantum efficiency and the distribution of nanocrystal sizes are improved in comparison to nanocrystals manufactured without the 1,2-diol or aldehyde or the amine.

The nanocrystal can be a member of a population of nanocrystals having a narrow size distribution. The nanocrystal can be a sphere, rod, disk, or other shape. The nanocrystal can include a core of a semiconductor material. The nanocrystal can include a core having the formula MX (e.g., for a II-VI semiconductor material) or M₃X₂ (e.g., for a II-V semiconductor material), where M is cadmium, zinc, magnesium, mercury, aluminum, gallium, indium, thallium, or mixtures thereof, and X is oxygen, sulfur, selenium, tellurium, nitrogen, phosphorus, arsenic, antimony, or mixtures thereof.

The emission from the nanocrystal can be a narrow Gaussian emission band that can be tuned through the complete wavelength range of the ultraviolet, visible, or infrared regions of the spectrum by varying the size of the nanocrystal, the composition of the nanocrystal, or both. For example, both CdSe and CdS can be tuned in the visible region and InAs can be tuned in the infrared region. Cd₃As₂ can be tuned from the visible through the infrared.

A population of nanocrystals can have a narrow size distribution. The population can be monodisperse and can exhibit less than a 15% rms deviation in diameter of the nanocrystals, preferably less than 10%, more preferably less than 5%. Spectral emissions in a narrow range of between 10 and 100 nm full width at half max (FWHM) can be observed. Semiconductor nanocrystals can have emission quantum efficiencies (i.e., quantum yields, QY) of greater than 2%, 5%, 10%, 20%, 40%, 60%, 70%, 80%, or 90%. In some cases, semiconductor nanocrystals can have a QY of at least 90%, at least 91%, at least 92%, at least 93%, at least 94%, at least 95%, at least 96%, at least 97%, at least 97%, at least 98%, or at least 99%.

Size distribution during the growth stage of the reaction can be estimated by monitoring the absorption line widths of the particles. Modification of the reaction temperature in response to changes in the absorption spectrum of the particles allows the maintenance of a sharp particle size distribution during growth. Reactants can be added to the nucleation solution during crystal growth to grow larger crystals. By stopping growth at a particular nanocrystal average diameter and choosing the proper composition of the semiconducting material, the emission spectra of the nanocrystals can be tuned continuously over the wavelength range of 300 nm to 5 microns, or from 400 nm to 800 nm for CdSe and CdTe. The nanocrystal has a diameter of less than 150 Å. A population of nanocrystals has average diameters in the range of 15 Å to 125 Å.

The core can have an overcoating on a surface of the core. The overcoating can be a semiconductor material having a composition different from the composition of the core. The overcoat of a semiconductor material on a surface of the nanocrystal can include a Group II-VI compound, a Group II-V compound, a Group III-VI compound, a Group III-V compound, a Group IV-VI compound, a Group I-III-VI compound, a Group II-IV-VI compound, and a Group II-IV-V compound, for example, ZnO, ZnS, ZnSe, ZnTe, CdO, CdS, CdSe, CdTe, MgO, MgS, MgSe, MgTe, HgO, HgS, HgSe, HgTe, AlN, AlP, AlAs, AlSb, GaN, GaP, GaAs, GaSb, InN, InP, InAs, InSb, TlN, TlP, TlAs, TlSb, TlSb, PbS, PbSe, PbTe, Cd₃As₂, Cd₃P₂ or mixtures thereof. For example, ZnS, ZnSe or CdS overcoatings can be grown on CdSe or CdTe nanocrystals. An overcoating process is described, for example, in U.S. Pat. No. 6,322,901. By adjusting the temperature of the reaction mixture during overcoating and monitoring the absorption spectrum of the core, over coated materials having high emission quantum efficiencies and narrow size distributions can be obtained. The overcoating can be between 1 and 10 monolayers thick.

Shells are formed on nanocrystals by introducing shell precursors at a temperature where material adds to the surface of existing nanocrystals but at which nucleation of new particles is rejected. In order to help suppress nucleation and anisotropic elaboration of the nanocrystals, selective ionic layer adhesion and reaction (SILAR) growth techniques can be applied. See, e.g., U.S. Pat. No. 7,767,260, which is incorporated by reference in its entirety. In the SILAR approach, metal and chalcogenide precursors are added separately, in an alternating fashion, in doses calculated to saturate the available binding sites on the nanocrystal surfaces, thus adding one-half monolayer with each dose. The goals of such an approach are to: (1) saturate available surface binding sites in each half-cycle in order to enforce isotropic shell growth; and (2) avoid the simultaneous presence of both precursors in solution so as to minimize the rate of homogenous nucleation of new nanoparticles of the shell material.

In the SILAR approach, it can be beneficial to select reagents that react cleanly and to completion at each step. In other words, the reagents selected should produce few or no reaction by-products, and substantially all of the reagent added should react to add shell material to the nanocrystals. Completion of the reaction can be favored by adding sub-stoichiometric amounts of the reagent. In other words, when less than one equivalent of the reagent is added, the likelihood of any unreacted starting material remaining is decreased.

The quality of core-shell nanocrystals produced (e.g., in terms of size monodispersity and QY) can be enhanced by using a constant and lower shell growth temperature. Alternatively, high temperatures may also be used. In addition, a low-temperature or room temperature “hold” step can be used during the synthesis or purification of core materials prior to shell growth.

The outer surface of the nanocrystal can include a layer of compounds derived from the coordinating agent used during the growth process. The surface can be modified by repeated exposure to an excess of a competing coordinating group to form an overlayer. For example, a dispersion of the capped nanocrystal can be treated with a coordinating organic compound, such as pyridine, to produce crystals which disperse readily in pyridine, methanol, and aromatics but no longer disperse in aliphatic solvents. Such a surface exchange process can be carried out with any compound capable of coordinating to or bonding with the outer surface of the nanocrystal, including, for example, phosphines, thiols, amines and phosphates. The nanocrystal can be exposed to short chain polymers which exhibit an affinity for the surface and which terminate in a moiety having an affinity for a suspension or dispersion medium. Such affinity improves the stability of the suspension and discourages flocculation of the nanocrystal. Nanocrystal coordinating compounds are described, for example, in U.S. Pat. No. 6,251,303, which is incorporated by reference in its entirety.

Monodentate alkyl phosphines (and phosphine oxides; the term phosphine below will refer to both) can passivate nanocrystals efficiently. When nanocrystals with conventional monodentate ligands are diluted or embedded in a non-passivating environment (i.e., one where no excess ligands are present), they tend to lose their high luminescence. Typical are an abrupt decay of luminescence, aggregation, and/or phase separation. In order to overcome these limitations, polydentate ligands can be used, such as a family of polydentate oligomerized phosphine ligands. The polydentate ligands show a high affinity between ligand and nanocrystal surface. In other words, they are stronger ligands, as is expected from the chelate effect of their polydentate characteristics.

In general, a ligand for a nanocrystal can include a first monomer unit including a first moiety having affinity for a surface of the nanocrystal, a second monomer unit including a second moiety having a high water solubility, and a third monomer unit including a third moiety having a selectively reactive functional group or a selectively binding functional group. In this context, a “monomer unit” is a portion of a polymer derived from a single molecule of a monomer. For example, a monomer unit of poly(ethylene) is —CH₂CH₂—, and a monomer unit of poly(propylene) is —CH₂CH(CH₃)—. A “monomer” refers to the compound itself, prior to polymerization, e.g., ethylene is a monomer of poly(ethylene) and propylene of poly(propylene).

A selectively reactive functional group is one that can form a covalent bond with a selected reagent under selected conditions. One example of a selectively reactive functional group is a primary amine, which can react with, for example, a succinimidyl ester in water to form an amide bond. A selectively binding functional group is a functional group that can form a noncovalent complex with a selective binding counterpart. Some well-known examples of selectively binding functional groups and their counterparts include biotin and streptavidin; a nucleic acid and a sequence-complementary nucleic acid; FK506 and FKBP; or an antibody and its corresponding antigen. See, e.g., U.S. Pat. No. 7,160,613, which is incorporated by reference in its entirety.

A moiety having high water solubility typically includes one or more ionized, ionizable, or hydrogen bonding groups, such as, for example, an amine, an alcohol, a carboxylic acid, an amide, an alkyl ether, a thiol, or other groups known in the art. Moieties that do not have high water solubility include, for example, hydrocarbyl groups such as alkyl groups or aryl groups, haloalkyl groups, and the like. High water solubility can be achieved by using multiple instances of a slightly soluble group: for example, diethyl ether is not highly water soluble, but a poly(ethylene glycol) having multiple instances of a CH2OCH₂ alkyl ether group can be highly water soluble.

For example, the ligand can include a polymer including a random copolymer. The random copolymer can be made using any method of polymerization, including cationic, anion, radical, metathesis or condensation polymerization, for example, living cationic polymerization, living anionic polymerization, ring opening metathesis polymerization, group transfer polymerization, free radical living polymerization, living Ziegler-Natta polymerization, or reversible addition fragmentation chain transfer (RAFT) polymerization.

In some cases, M belongs to group II and X belongs to group VI, such that the resulting semiconductor nanocrystal includes a II-VI semiconductor material. For example, the M-containing compound can be a cadmium-containing compound and the X donor can be a selenium donor or an sulfur donor, such that the resulting semiconductor nanocrystal includes a cadmium selenide semiconductor material or a cadmium sulfide semiconductor material, respectively.

The particle size distribution can be further refined by size selective precipitation with a poor solvent for the nanocrystals, such as methanol/butanol as described in U.S. Pat. No. 6,322,901. For example, nanocrystals can be dispersed in a solution of 10% butanol in hexane. Methanol can be added dropwise to this stirring solution until opalescence persists. Separation of supernatant and flocculate by centrifugation produces a precipitate enriched with the largest crystallites in the sample. This procedure can be repeated until no further sharpening of the optical absorption spectrum is noted. Size-selective precipitation can be carried out in a variety of solvent/nonsolvent pairs, including pyridine/hexane and chloroform/methanol. The size-selected nanocrystal population can have no more than a 15% rms deviation from mean diameter, preferably 10% rms deviation or less, and more preferably 5% rms deviation or less.

More specifically, the coordinating ligand can have the formula:

(Yₖ₋ₙXL)ₙ

wherein k is 2, 3 or 5, and n is 1, 2, 3, 4 or 5 such that k-n is not less than zero; X is O, S, S═O, SO₂, Se, Se═O, N, N═O, P, P═O, As, or As═O; each of Y and L, independently, is aryl, heteroaryl, or a straight or branched C₂₋₁₂ hydrocarbon chain optionally containing at least one double bond, at least one triple bond, or at least one double bond and one triple bond. The hydrocarbon chain can be optionally substituted with one or more C₁₋₄ alkyl, C₂₋₄ alkenyl, C₂₋₄ alkynyl, C₁₋₄ alkoxy, hydroxyl, halo, amino, nitro, cyano, C₃₋₅ cycloalkyl, 3-5 membered heterocycloalkyl, aryl, heteroaryl, C₁₋₄ alkylcarbonyloxy, C₁₋₄ alkyloxycarbonyl, C₁₋₄ alkylcarbonyl, or formyl. The hydrocarbon chain can also be optionally interrupted by —O—, —S—, —N(R^{a})—, —N(R^{a})—C(O)—O—, —O—C(O)—N(R^{a})—, —N(R^{a})—C(O)—N(R^{b})—, —O—C(O)—O—, —P(R^{a})—, or —P(O)(R^{a})—. Each of R^{a} and R^{b}, independently, is hydrogen, alkyl, alkenyl, alkynyl, alkoxy, hydroxylalkyl, hydroxyl, or haloalkyl.

A suitable coordinating ligand can be purchased commercially or prepared by ordinary synthetic organic techniques, for example, as described in J. March, Advanced Organic Chemistry, which is incorporated by reference in its entirety.

Transmission electron microscopy (TEM) can provide information about the size, shape, and distribution of the nanocrystal population. Powder X-ray diffraction (XRD) patterns can provide the most complete information regarding the type and quality of the crystal structure of the nanocrystals. Estimates of size are also possible since particle diameter is inversely related, via the X-ray coherence length, to the peak width. For example, the diameter of the nanocrystal can be measured directly by transmission electron microscopy or estimated from X-ray diffraction data using, for example, the Scherrer equation. It also can be estimated from the UV/Vis absorption spectrum.

Multiplexed Spectrometer

The spectrometer is credited as an important tool to the development and progress of modern science. See, for example, Harrison, G. R. The production of diffraction gratings 1. Development of the ruling art. J. Opt. Soc. Am. 39, 413-426 (1949). In order to extend the use of spectrometers into fields and applications beyond the reach of conventional bulky and expensive ones, tremendous efforts have been afforded to developing smaller and cheaper miniaturized spectrometers (or microspectrometers) during the recent years, and have resulted in unprecedentedly small spectrometers, some with promising spectral resolving power. See, for example, Wolffenbuttel, R. F. State-of-the-art in integrated optical microspectrometers. IEEE Trans. Instrum. Meas. 53, 197-202 (2004), and Wolffenbuttel, R. F. MEMS-based optical mini- and microspectrometers for the visiable and infrared spectral range. J. Micromech. Microeng. 15, S145-S152 (2005), each of which is incorporated by reference in its entirety. However, most microspectrometers demonstrated so far are limited by their intrinsic characteristics, and are unable to meet all the performance and cost benefits needed, leaving ample room for improvements. A new way of making spectrometers is demonstrated which does not require any dispersive or reflective optics or any scanning mechanism, but rather in a multiplexing way simply making use of colloidal quantum dot absorptive filters and an array of photodetectors. Such a spectrometer design provides a way to wide spectral range, high resolution and high throughput microspectrometers whose performance is not intrinsically limited. Combined with various quantum dot printing technologies (see, for example, Kim, L. et al. Contact printing of quantum dot light-emitting devices. Nano Lett. 8, 4513-4517 (2008), Wood, V. et al. Inkjet-printed quantum dot-polymer composites for full-color AC-driven displays. Adv. Mater. 21, 1-5 (2009), and Kim, T. et al. Full-colour quantum dot displays fabricated by transfer printing. Nat. Photon. 5, 176-182 (2011), each of which is incorporated by reference in its entirety) and optical sensor arrays, such solution processed quantum dot filters could be integrated into single-chip microspectrometers with significantly reduced design and assembly complexities.

The semiconductor nanocrystal filters disclosed herein can be reduced in size and assembled to a detector array. The system can also include a light source, circuit boards, a powering unit, and an output system. These units can be assembled in a way such that the entire system is compact, portable, and rugged.

As spectrometers are more and more heavily used in almost every field where light interacts with matter, the need for smaller and cheaper spectrometers becomes ever stronger. An integrated single-chip microspectrometer costing similar to a board camera but functioning as a conventional grating based spectrometer could greatly benefit applications, such as space explorations where every gram counts, surgical and clinical procedures and personal medical diagnostics where both size and price matter significantly, and various spectral imaging applications where reduced unit size, cost and complexity are critical to the integration of spectrometers and imaging devices. See, for example, Gat N. Imaging spectroscopy using tunable filters: A review. Proc. SPIE 4056, 50-64 (2000), Bacon, C. P., Mattley, Y. & DeFrece, R. Miniature spectroscopic instrumentation: Applications to biology and chemistry. Rev. Sci. Instrum. 75, 1-16 (2004), and Garini, Y., Young, I. T. & McNamara, G. Spectral imaging: Principles and applications. Cytometry Part A 69A, 735-747 (2006), each of which is incorporated by reference in its entirety. Current microspectrometer designs mostly fall into two categories, micromachined grating-based and integrated interference filter-based, both of which temporally or spatially separate different wavelength components of a light spectrum with interference based optics prior to measurements. While having limited throughput and spectral ranges due to that of interference based optics, grating-based microspectrometers could only offer very low spectral resolution due to the inherent short optical path in a microsystem and difficulty in micromachining scattering-free surfaces. On the other hand, there are three major interference filter approaches currently being developed, namely tunable Fabry-Perot, discrete filter array and linear variable filter. Although these microspectrometers could provide much higher spectral resolutions, their throughput and spectral ranges are still limited by their interference nature in addition to the performance limiting practical considerations in terms of fabrication and operation.

Instead of measuring different light components individually after temporal or spatial separations with dispersive optics or interference based filters (FIG. 5), a light spectrum can also be analyzed in a multiplexing way. See, for example, James, J. F. & Sternberg, R. S. The Design of Optical Spectrometers Ch. 8 (Chapman & Hall, London, 1969), which is incorporated by reference in its entirety. That is to simultaneously detect multiple light components in an encoded way such that the light spectrum can be reconstructed with a post measurement calculation. Because different light components can be utilized simultaneously rather than having most intensities discarded, multiplexing spectrometers could offer much greater throughput. Both Fourier transform and Hadamard transform spectrometers are based on multiplexing designs. See, for example, Harwit, M. & Sloane, N. J. A. Hadamard Transform Optics P.3. (Academic Press, New York. 1979), which is incorporated by reference in its entirety. However, such spectrometer designs do not scale down well due to various fabrication and operation difficulties, especially when they involve a scanning mechanism. Therefore most miniature spectrometers fall out of this range. See, for example, Crocombe, R. A. Miniature optical spectrometers: There's plenty of room at the bottom Part I, Background and mid-infrared spectrometers. Spectroscopy. 23, 38-56 (2008), which is incorporated by reference in its entirety. Alternatively, multiplexing spectrometers can also be made based on broad spectral absorptive color filters. Unlike interference based optics, absorptive filters based on atomic, molecular or plasmonic resonances do not suffer from the intrinsic conflict between the spectral range and resolution, and could potentially offer high throughput, wide spectral range and high resolution at the same time. In addition, when assembled into an array, such absorptive color filters can offer free-of-scan spectrometers which take spectral measurements with snapshots.

Referring to FIG. 5, a comparison of the operation principles of different spectrometer approaches is shown. With a dispersive optics based spectrometer design (shown in the top path), different wavelength components of a light spectrum can be first spatially separated or dispersed, and then intensities of different components are measured individually. As intensities of different wavelengths can result directly from measurements, the light spectrum can be read out without further processing. With the interference filter based spectrometer design (shown in the middle path), the same light spectrum can be evenly distributed over a range of interference filters either spatially or temporally separated from each other (shown in the middle path is a set of spatially separated discrete interference filters). As each interference filter only allows a very narrow wavelength band to pass, the entire setup effectively separates different wavelengths of the light spectrum either spatially or temporally. Similar to the first approach, the light spectrum can be directly read without further processing. With the broad spectra filter multiplexing design (shown in the bottom path), the light spectrum also can be evenly distributed over a range of different filters. However, as all filters transmit at most of the wavelength range but at different levels, there can be no wavelength separation involved. Nevertheless, spectrally differentiated information about the original light spectrum is embedded in the transmitted intensities. With a least square linear regression based on the filter transmission spectra and recorded spectrally differentiated intensities, the original light spectrum can be reconstructed.

Pivotal to the success of the absorptive multiplexing spectrometer approach is the availability of a rich and scalable collection of diversified yet continuously tunable absorptive filters, with system integration compatibility in an economic way. As it is difficult to meet such requirements with conventional absorptive filter materials such as dyes and pigments, this spectrometer approach has not been able to prevail. However, quantum dot (QD or semiconductor nanocrystal), as a new class of filtering materials, turns out to be a good fit and offers a promising solution. Semiconductor nanocrystals are semiconductor nanocrystals whose radii are typically smaller than the bulk exciton Bohr Radius which leads to quantum confinement of electrons and holes in all three dimensions. Therefore, as the size decreases, stronger quantum confinement results in a larger effective band gap and blue shift in both optical absorption and fluorescent emission. Over the past three decades, enormous efforts have been devoted into making and understanding them. See, for example, Alivisatos, A. P. Semiconductor clusters, nanocrystals, and quantum dots. Science 271, 933-937 (1996), Murray, C. B., Kagan, C. R. & M. G. Bawendi. Synthesis and characterization of monodisperse nanocrystals and close-packed nanocrystal assemblies. Annu. Rev. Mater. Sci. 30, 545-610 (2000), and Peng, X. An essay on synthetic chemistry of colloidal nanocrystals. Nano Res. 2, 425-447 (2009), each of which is incorporated by reference in its entirety. These efforts have established a library and made available a large collection of semiconductor nanocrystals whose absorption spectra can be tuned continuously and finely over a wide range of wavelengths from deep UV to far IR simply by tuning the size, shape and composition of such materials. See, for example, Steigerwald, M. L. & Brus, L. E. Semiconductor crystallites: a class of large molecules. Acc. Chem. Res. 23, 183-188 (1990), Murray, C. B., Norris, D. J. & Bawendi, M. G. Synthesis and characterization of nearly monodisperse CdE (E=sulfur, selenium, tellurium) semiconductor nanocrystallites. J. Am. Chem. Soc. 115, 8706-8715 (1993), Peng, X. et al. Shape control of CdSe nanocrystals. Nature 404, 59-61 (2000), and El-Sayed, M. A. Small is different: shape-, size-, and composition-dependent properties of some colloidal semiconductor nanocrystals. Acc. Chem. Res. 37, 326-333 (2004), each of which is incorporated by reference in its entirety. Furthermore, many demonstrations have successfully showed that semiconductor nanocrystals can be readily printed into very fine patterns with well developed and widely used technologies. These facts make semiconductor nanocrystals a perfect candidate for filter-based spectrometers.

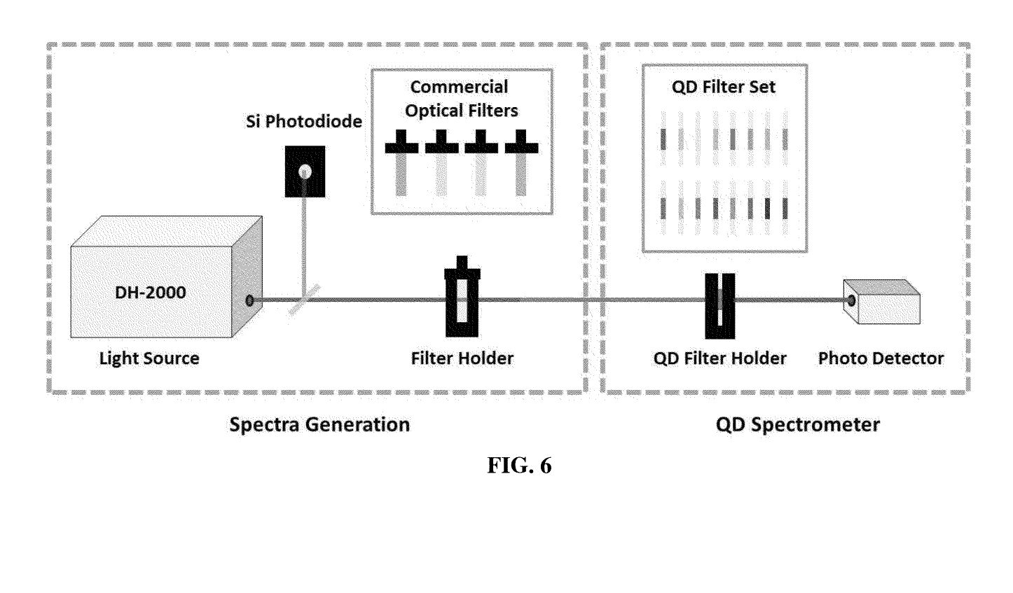

Referring to FIG. 6, an optical measurement setup for a semiconductor nanocrystal spectrometer is shown. Different light sources can be generated with a Deuterium Tungsten Halogen light source and various randomly selected commercial optical filters. A beam splitter and silicon photodiode can be used to monitor the source intensity fluctuations throughout the measurements to ensure consistency. The demonstrated semiconductor nanocrystals spectrometer can be simply composed of a set of semiconductor nanocrystal absorptive filters and a photo detector for measuring light intensities after each semiconductor nanocrystal filter.

The basic operation of semiconductor nanocrystal spectrometers can involves direct measurement of spectrally differentiated intensities of a light source spectrum after different filters and spectral reconstruction from this collection of data. Specifically in this demonstration, a series of light sources whose spectra (Φ(λ) are to be characterized by the semiconductor nanocrystal spectrometer are simulated by applying a variety of commercial optical filters to the output of a Deuterium Tungsten Halogen (DTH) light source as illustrated in the figure (FIG. 6). During measurement, a light source is sent through a set of semiconductor nanocrystal absorptive filters (Fᵢ, where i is the filter number, totaling nᵢ) one at a time and transmitted light intensities (Iᵢ) are recorded by a photo detector after each filter. The intensities recorded follow the equation below:

Σ_{λ}Φ(λ)Tᵢ(λ)R(λ)=Iᵢ (1)

where R(λ) is the responsivity of the photo detector used, Tᵢ(λ) is the transmission spectrum of a semiconductor nanocrystal filter (Fᵢ) out of the filter set, and Φ(λ) is the light source spectrum which is under investigation. The entire semiconductor nanocrystal filter set (with a total filter number of nᵢ) with each filter having a different transmission spectrum (Tᵢ(λ)) results in a total number of nᵢ intensities (Iᵢ) through measurements, and thus nᵢ equations in the form of equation (1). As the transmission spectrum (Tᵢ(λ)) of each semiconductor nanocrystal filter and the responsivity of the photo detector R(λ) can both be predetermined through characterizations, the entire set of equations has only one common unknown as Φ(λ), which is a spectrum composed of a set of variables at discrete λ values (totaling n_{λ}, depending on the spectral range and the wavelength interval). The larger n_{λ} within a given spectral range would the system be able to determine, the larger the spectral resolution can be. However, fundamentally n_{λ} is limited by the number of different equations and thus the number of different filters (Iᵢ) used during measurements.

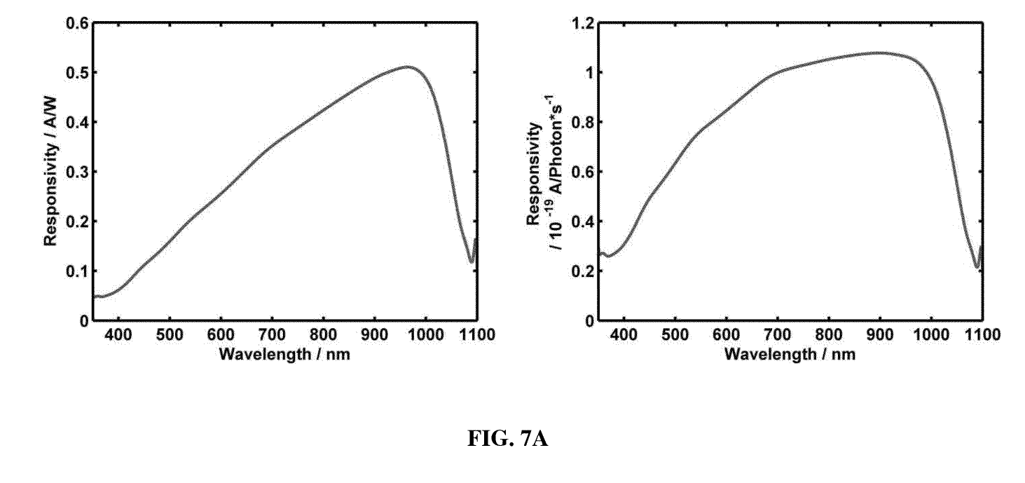

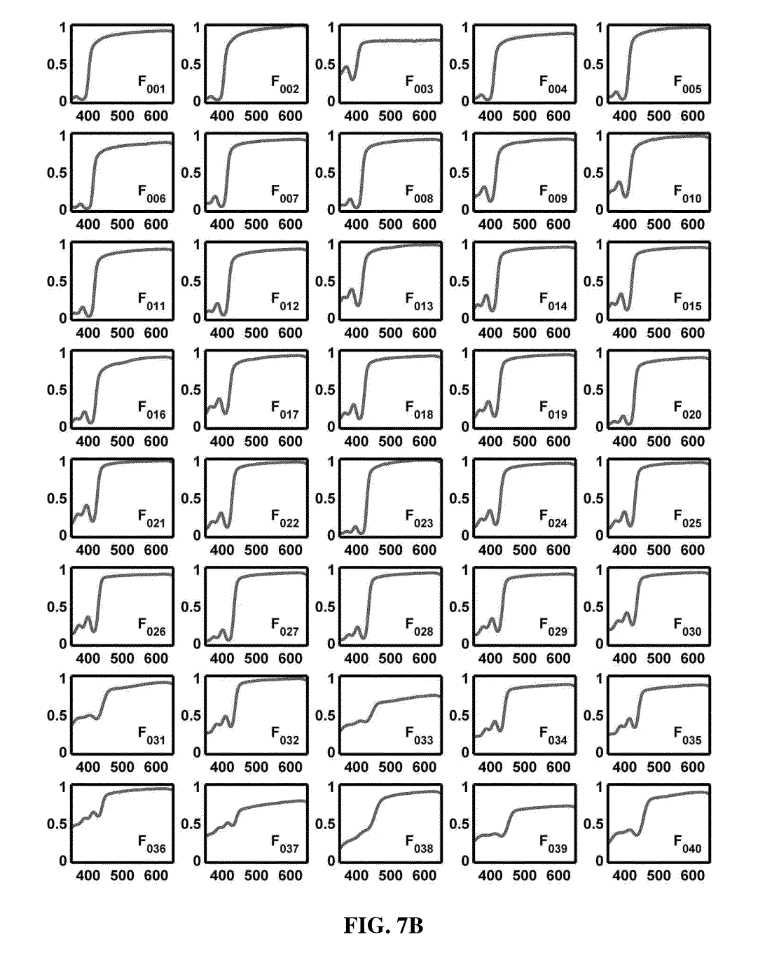

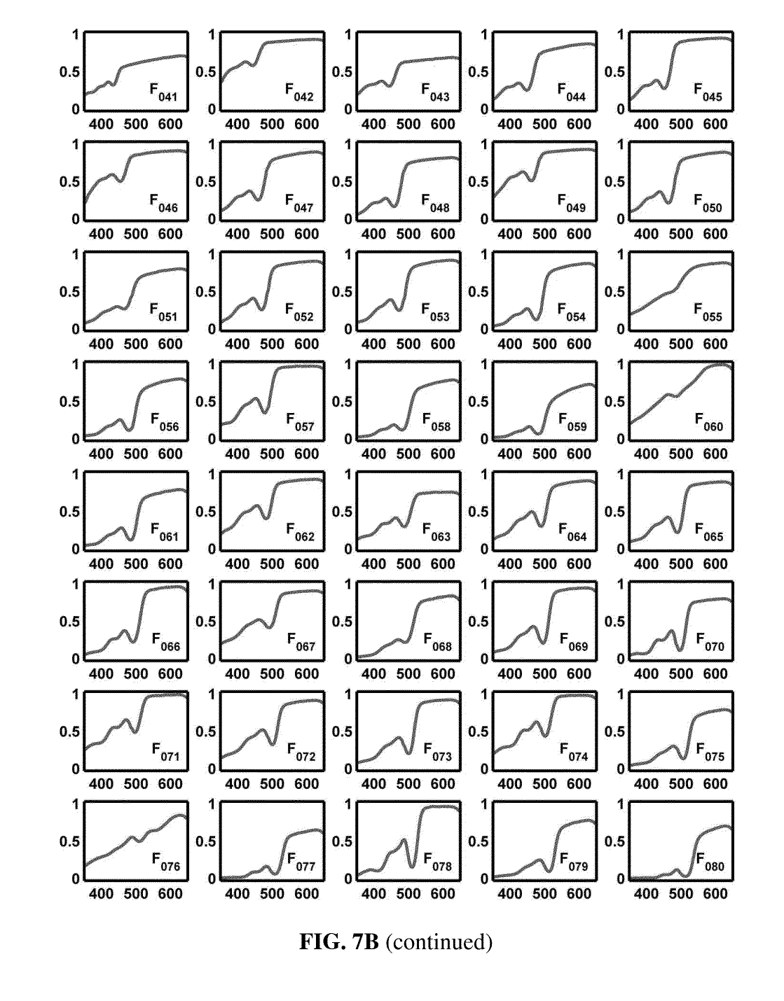

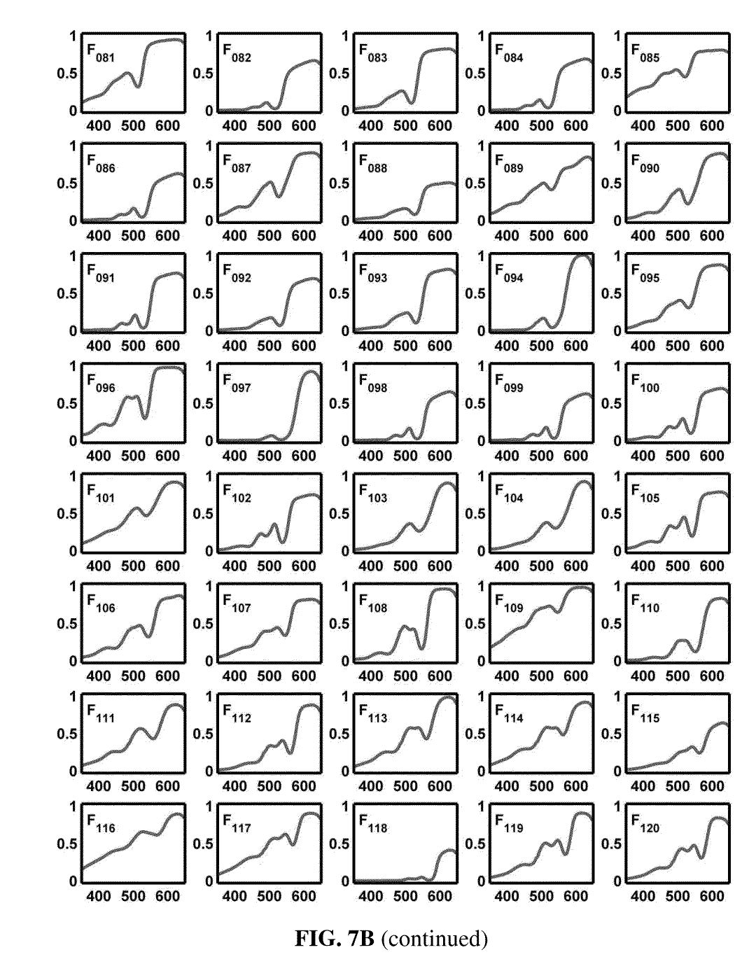

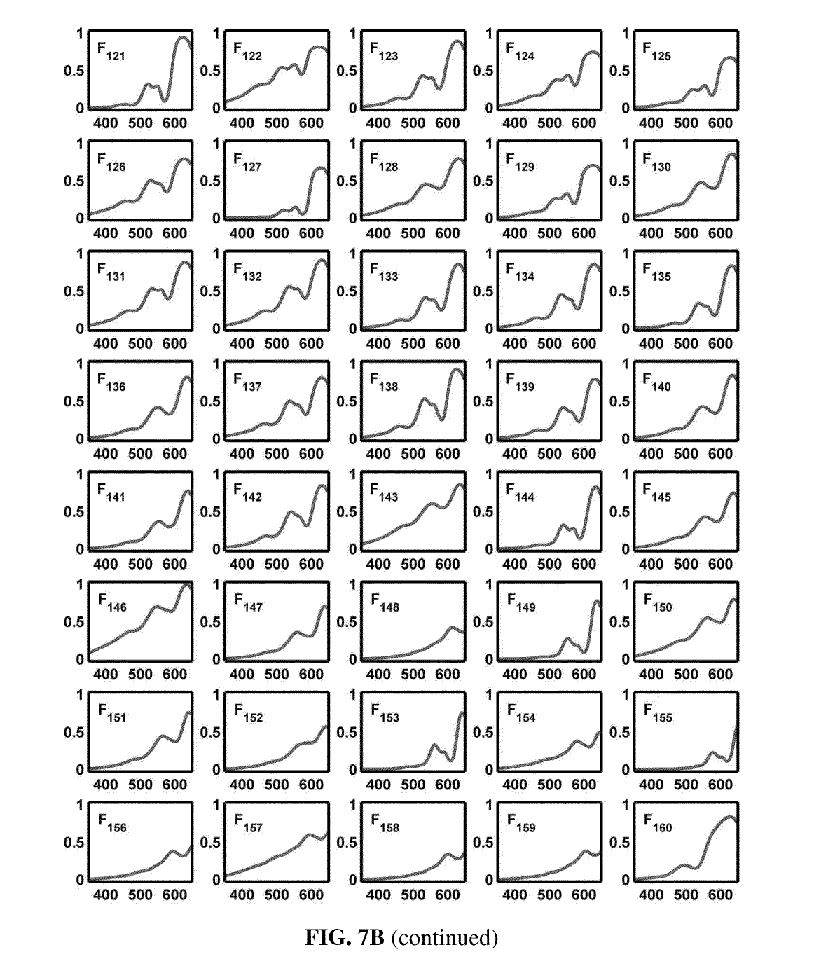

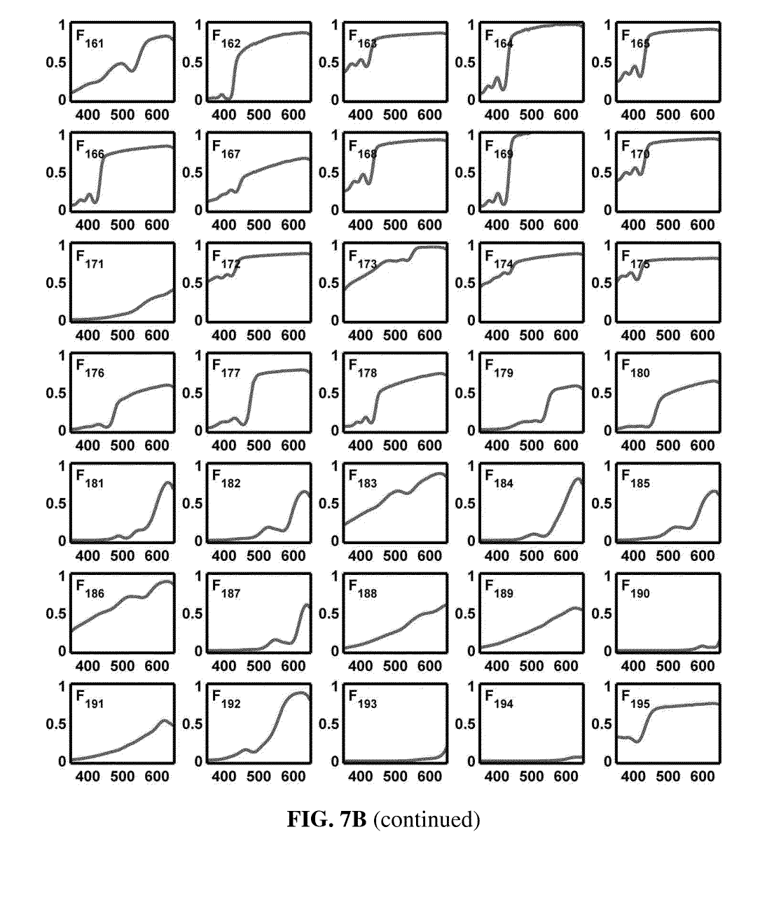

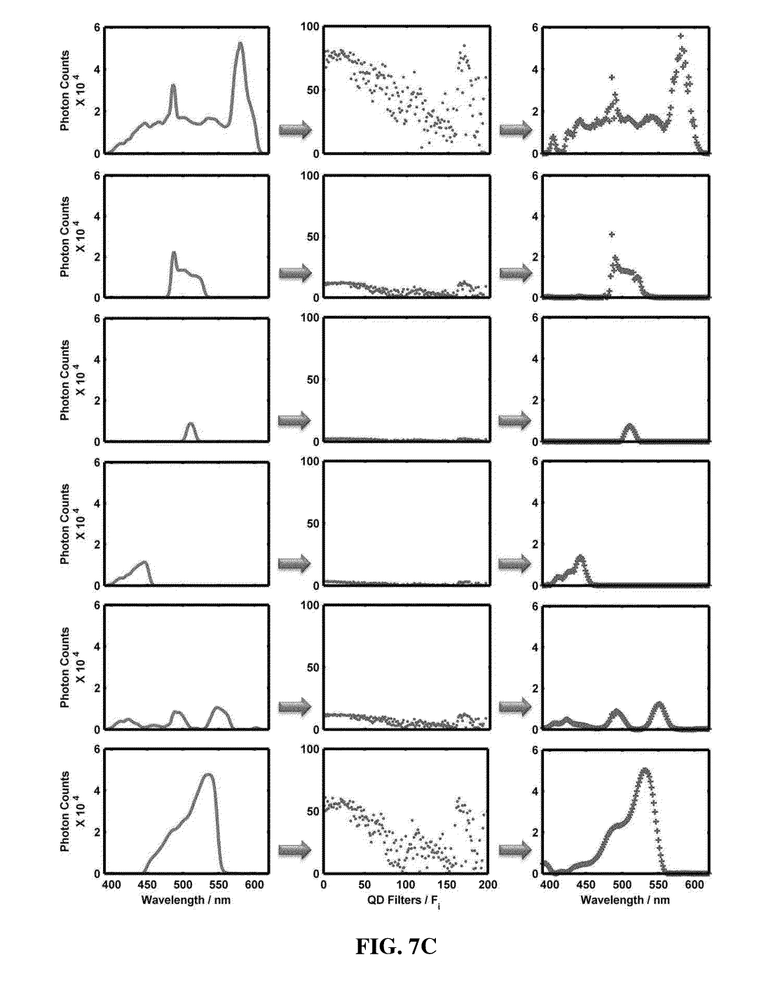

In order to reconstruct a light spectrum (Φ(λ)), R(λ), Tᵢ(λ) and Iᵢ are needed. For example, when the semiconductor nanocrystal filters are characterized with a continuously tunable monochromatic light source and a photo detector such as a silicon photodiode, the silicon photodiode can also be used directly as the photo detector for measurements of the transmitted light intensities. To take into consideration the responsivity of a typical silicon photodiode, when it is used in place of the spectrometer for intensity measurements, the spectra integration was weighted by a detector responsivity function (R(λ)) taken from a calibrated silicon photodiode (R(λ) is shown in FIG. 7A. Iᵢ for each light source are shown in FIG. 7C) according to the following equation:

Iᵢ=Σ_{λ}Ψᵢ(λ)R(λ) (2)

The responsivity function (R(λ)) used in equation (1) during spectral reconstruction is the same as the one shown in equation (2).

Worth mentioning is that the semiconductor nanocrystals prepared with different procedures possess different levels of fluorescence quantum yields. The emissions, when stabilized and well calibrated, may be beneficial as a way of amplifying the difference between filters. On the other hand, the emissions could also introduce further complexity. As a result, the emissions of these semiconductor nanocrystals were quenched with p-phenylenediamine. See, for example, Chen, O. et al. Synthesis of metal-selenide nanocrystals using selenium dioxide as the selenium precursor. Angew. Chem. Int. Ed. 47, 8638-8641 (2008), which is incorporated by reference in its entirety. In addition, a distance was kept between the semiconductor nanocrystal filters and the photo detector to ensure the maximum emission influence is well below 0.1%. Therefore, only absorptions were considered in the experiments and calculations.

The responsivity of a Si photodiode (R(λ)) is plotted in FIG. 7A. It corresponds to R(λ) in equation (1) and (2). Both plots represent the same responsivity but in different units. Individual transmission spectra (Tᵢ(λ)) of 195 semiconductor nanocrystal filters (Fᵢ, where i is the filter number) are plotted in FIG. 7B. In each subplot, the unit for the horizontal axis is nm and the vertical axis is transmission (100%). Transmitted light intensities of light sources after passing through semiconductor nanocrystal filters (Iᵢ) are shown in FIG. 7C. Shown in the 6 subplots with red solid lines are the six light source spectra. In the corresponding plots in green dots to their right, we plot the 195 light intensities (Iᵢ) after the light source passing through 195 semiconductor nanocrystal filters (Fᵢ). Each green dot represents an intensity resulted from the corresponding light source passing through a semiconductor nanocrystal filter (producing a spectrum of Ψᵢ(λ)) and integrated as such: Iᵢ=Σ_{λ}Ψᵢ(λ)R(λ), where R(λ) represents the responsivity of a Si photodiode (FIG. 7A). The right most column displays the reconstructed spectra for each corresponding light source. The vertical axis of each subplot is exactly the same as one another and is represented by the axis labels to the left side of each row. The horizontal axis of each subplot is represented by the corresponding axis label at the bottom of each column.

In the ideal case when there is no measurement error involved, n_{λ} equals to nᵢ as it is equivalent to solving a set of linear equations with a unique solution. However, this will not be the case in reality as there will always be measurement errors, which typically render the system inconsistent and equations with no solution. However, approximate solutions can be derived based on least squares linear regression. Under such errors-in-variables conditions, a given number of different filters (nᵢ) can no long provide an equal number of spectral data points effectively and accurately (n_{λ}<nᵢ), and the larger the error, the more filters are required for each meaningful spectral data point.

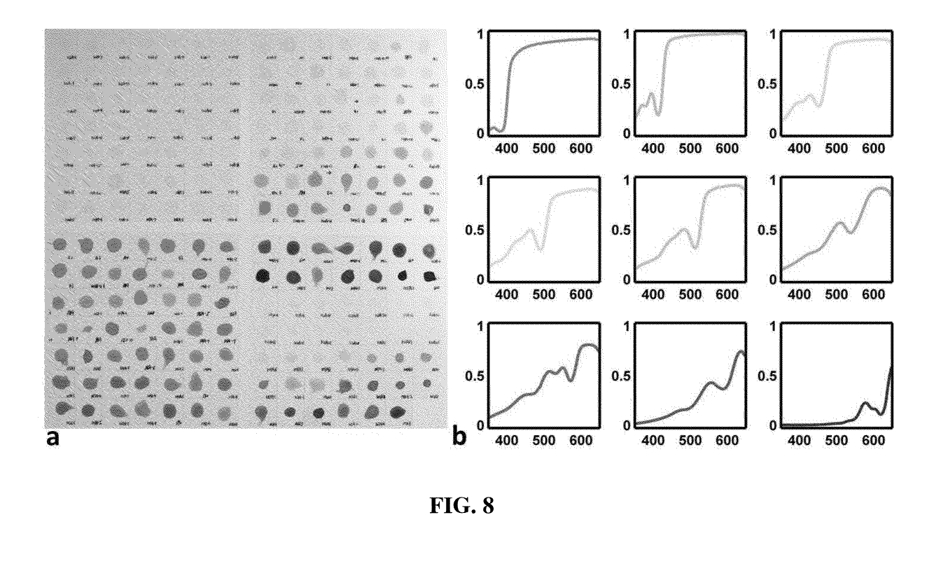

Referring to FIGS. 8A and 8B, semiconductor nanocrystal filters can be prepared on cover slips that retain the transmission spectra of the constituent nanocrystals. In FIG. 8A, 195 semiconductor nanocrystal filters on cover slips show that each filter can be made of CdS or CdSe semiconductor nanocrystals embedded in a thin polyvinyl butyral film supported by a cover slip. In FIG. 8B, select transmission spectra of some of the filters shown in FIG. 8A are presented. In each subplot, the unit for the horizontal axis is nm and the vertical axis is transmission (100%).

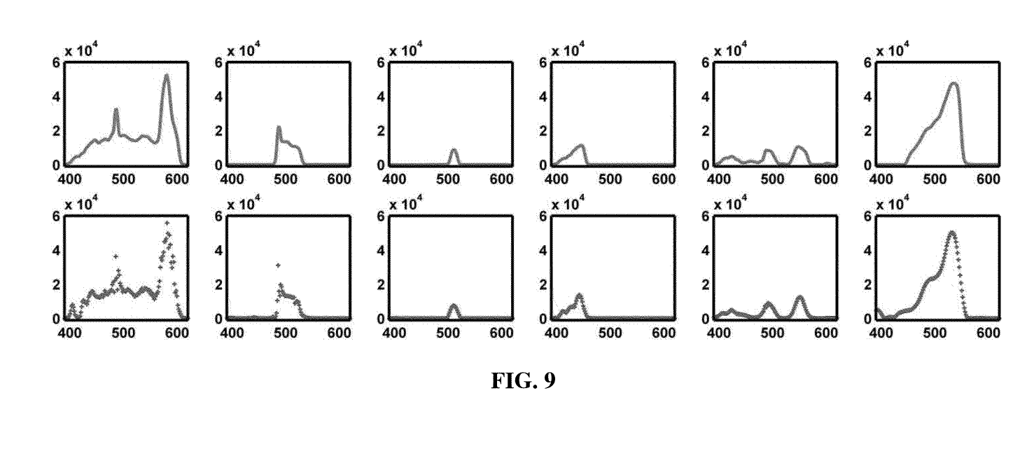

In this demonstration, a 230 nm spectral range (390 nm˜620 nm) is selected without loss of generality and 195 different semiconductor nanocrystals filters (FIG. 8A) used are made out of 195 different kinds of semiconductor nanocrystals whose size or composition vary from one another. Filter characterizations (FIG. 8B, individual transmission spectra of filters are shown in FIG. 7B) are performed with the DTH light source and an Ocean Optics spectrometer (˜0.8 nm spectral data point interval) with a measurement error of a standard deviation of σ=0.022. (The error level was evaluated by comparing, with root mean square, the differences between 195 Iᵢ integrated from equation (2) and 195 Iᵢ calculated from equation (3) with the measured Φ(λ) which are shown in top subplots in FIG. 9) Given the above situations, the linear regression algorithm was asked to provide a spectral data point of the unknown spectrum (Φ(λ)) every 1.6 nm, totaling 147 data points. Shown in the figure (FIG. 9) are directly reconstructed spectra of 6 different light sources. It is shown that the demonstrated semiconductor nanocrystal spectrometer can faithfully reproduce all the main features of each spectrum tested, with different intensity levels and different spectral width across the entire tested wavelength range. The mismatch between the light source spectra measured by the Ocean Optics spectrometer and the semiconductor nanocrystal spectrometer at sharp peaks and subtle features are due to system measurement errors and the limited number of semiconductor nanocrystal filters used. It is expected that improvement in the spectral resolution can be achieved from an increase in the number of filters used and a decrease in the measurement error. (The measurement error can be decreased, for instance, by a non-linearity calibration of the photo detector, reduced measurement durations and removed mechanical filter switching procedures with a fully integrated spectrometer) Additional simulation evidences are shown in Section II and III in the Appendix.

Referring to FIG. 9, light source spectra can be reconstructed by the semiconductor nanocrystal spectrometer. Shown in the upper solid lines in the top subplots are 6 light source spectra generated by applying various commercial optical filters to a Deuterium Tungsten Halogen light source, and measured by the QE65000 spectrometer. Directly reconstructed spectral data points based on semiconductor nanocrystal spectrometer measurements and least squares linear regression are shown with crosses in the bottom subplots, corresponding to each light source subplot respectively. The horizontal axes represent wavelength in nm. The vertical axes represent photon counts from photodetectors.

As suggested by the spectrometer operation principle and the availability of semiconductor nanocrystals over a very wide spectral range, a semiconductor nanocrystal spectrometer could potentially provide a high spectral resolving power with a spectral range limited only by that of the photo detector. Moreover, integrated semiconductor nanocrystal spectrometers can be fabricated by printing the solution processable semiconductor nanocrystals onto detector arrays for the spectrometers to further benefit from the simplicity of design and the minimum needs for optics and alignments. Various materials can be used, such as plasmonic nanostructures, carbon nanotubes and photonic crystals, as well as other spectrometer designs based on semiconductor nanocrystals, See, for example, Jain, P. K., Huang, X., El-Sayed, I. H. & El-Sayed, M. A. Noble metals on the nanoscale: optical and photothermal properties and some applications in imaging, sensing, biology, and medicine. Acc. Chem. Res. 41, 1578-1586 (2008), Laux, E., Genet, C., Skauli, T. & Ebbesen, T. W. Plasmonic photon sorters for spectral and polarimetric imaging. Nat. Photon. 2, 161-164 (2008), Xu, T., Wu, Y., Luo, X. & Guo, J. Plasmonic nanoresonators for high-resolution colour filtering and spectral imaging. doi:10.1038/ncomms1058 (2010), Baughman, R. H., Zakhidov, A. A. & de Heer, W. A. Carbon nanotubes—the route toward applications. Science 297, 787-792 (2002), Joannopoulos, J. D., Villeneuve, P. R. & Fan, S. Photonic crystals: putting a new twist on light. Nature 386, 143-149 (1997), Xu, Z. et al. Multimodal multiplex spectroscopy using photonic crystals. Opt. Exp. 11, 2126-2133 (2003), Momeni, B., Hosseini, E. S., Askari, M., Soltani, M. & Adibi, A. Integrated photonic crystal spectrometers for sensing applications. Opt. Comm. 282, 3168-3171 (2009), and Jimenez, J. L. et al. The quantum dot spectrometer. Appl. Phys. Lett. 71, 3558-3560 (1997), each of which is incorporated by reference in its entirety. The plasmonic nanostructures, carbon nanotubes or photonic crystals can be used alone or in combination with semiconductor nanocrystals. The use of other materials such as photonic crystals and linear variable filters in combination with semiconductor nanocrystals can allow other spectrometers to be built that can achieve improved performance and can be used for specialized applications. Each material can be used in combination with the demonstrated design for further improvements and dedicated purposes and better algorithms may also offer additional accuracy. In addition, such semiconductor nanocrystal spectrometers could also be made directly with semiconductor nanocrystal photo detectors with different responsivity profiles, which perform the integrated function of light filtering and detection. Such semiconductor nanocrystal detectors can be further vertically stacked on top of one another similar to the tandem cell format so that the entire spectrometer would only take the space of one imaging pixel. Thereby a matrix of such pixel-sized spectrometers placed in the focal plane of an imaging lens can enable spectral imaging devices, which take spectral images with snapshots without scanning in any sense.

In some examples, instead of using exclusively semiconductor nanocrystals in the form of quantum dots, various other materials, which can potentially produce a variety of or increase the variety of detector response profiles in the form of altering absorption, reflection, quantum yield and etc., can also be used and operated in these principles or a subset of these principles as a spectrometer. These materials can include, but are not limited to: semiconductor nanocrystal nanorods, nanostars, nano plates, triangles, tri-pods, any other shapes and geometries; carbon nanotubes; dye molecules; any materials that can produce a continuously tunable band gap; gold/silver or other metal nanorods, nano particles, and other shapes and geometries; filtering and coloring materials that are being used in currently light related activities; and any chemicals that can help altering the spectrum of these materials which result in an alternation to the response profile of the detectors. Semiconductor nanocrystals can be mixed with other materials to modify their absorption/fluorescence properties. For example, semiconductor nanocrystals can be mixed with p-phenylenediamine, which significantly quenches their fluorescence emission. See, for example, Sharma, S. N., Pillai, Z. S. & Kamat, P. V. Photoinduced charge transfer between CdSe quantum dots and p-phenylenediamine. J. Phys. Chem. B 107, 10088-10093 (2003)), which is incorporated by reference in its entirety. Semiconductor nanocrystals can also be mixed with carbon nanotubes, which can ater both the absorption and the emission of the mixture. See, for example, Adv. Funct. Mater. 2008, 18, 2489-2497; Adv. Mater. 2007, 19, 232-236, which is incorporated by reference in its entirety. Semiconductor nanocrystals can also be mixed with metal nanoparticles. See, for example, J. Appl. Phys. 109, 124310 (2011); Photochemistry and Photobiology, 2002, 75(6): 591-597, which is incorporated by reference in its entirety. Semiconductor nanocrystals can form semiconductor nanocrystal-metal heterostructures so that both absorption and fluorescence can be altered. See, for example, Nature Nanotechnology 4, 571-576 (2009), which is incorporated by reference in its entirety. Other materials include dyes, pigments, and molecular agents such as amines, acids, bases, and thiols. See, for example, Nanotechnology 19 (2008) 435708 (8 pp); J. Phys. Chem. C 2007, 111, 18589-18594; J. Mater. Chem., 2008, 18, 675-682, which is incorporated by reference in its entirety. The above mentioned materials can be used independently or in any sorts of combinations. For example, one or more materials can be added to another material so that the original spectrum and response profiles changes after the addition. It can also be used in the way that different materials or materials combination are stacked on top of one another. These materials when used as a coupler to another light detector such as CCD and CMOS, or others, can be printed directly on top of the detector or detector pixels, where different detector/pixels receive different materials/materials combinations, or these different materials/materials combinations can be pre-made into a mask, film or pattern as an additional component to the pre-made detector or detector arrays, so that effectively, and the two patterns can be aligned to one in a designed way. There could be any number of detectors used, separately or collectively as a detector array. These detectors include, but not limited to image intensifier; flame sensors (UVtron®); intensified cameras/ICCD, aActive pixel sensors as image sensors, including CMOS APS commonly used in cell phone cameras, web cameras, and some DSLRs, and an image sensor produced by a CMOS process, also known as a CMOS sensor as an alternative to charge-coupled device (CCD) sensors; charge-coupled devices (CCD), which are used to record images in astronomy, digital photography, and digital cinematography; chemical detectors, such as photographic plates, in which a silver halide molecule is split into an atom of metallic silver and a halogen atom; cryogenic detectors that are sufficiently sensitive to measure the energy of single x-ray, visible and infrared photons; LEDs reverse-biased to act as photodiodes; optical detectors, which are mostly quantum devices in which an individual photon produces a discrete effect; photoresistors or Light Dependent Resistors (LDR) which change resistance according to light intensity; photovoltaic cells or solar cells which produce a voltage and supply an electric current when illuminated; photodiodes which can operate in photovoltaic mode or photoconductive mode; photomultiplier tubes containing a photocathode which emits electrons when illuminated, the electrons then amplified by a chain of dynodes; phototubes containing a photocathode which emits electrons when illuminated, such that the tube conducts a current proportional to the light intensity; phototransistors, which act like amplifying photodiodes; and semiconductor nanocrystal photoconductors or photodiodes, which can handle wavelengths in the UV, visible and infrared spectral regions.

The individual detector pixel and the overall detecting unit sizes can be any sizes that are possible with manufacturing. For example in the case of charge-coupled device detectors, they can have 3 μm×3 μm pixels with 1 mm×1 mm sensors (for example, a NanEye Camera). It could also be 14×500 μm and 28.6×0.5 mm (for example, a CCD sold by Hamamatsu) or even a 0.9 m² sensor.

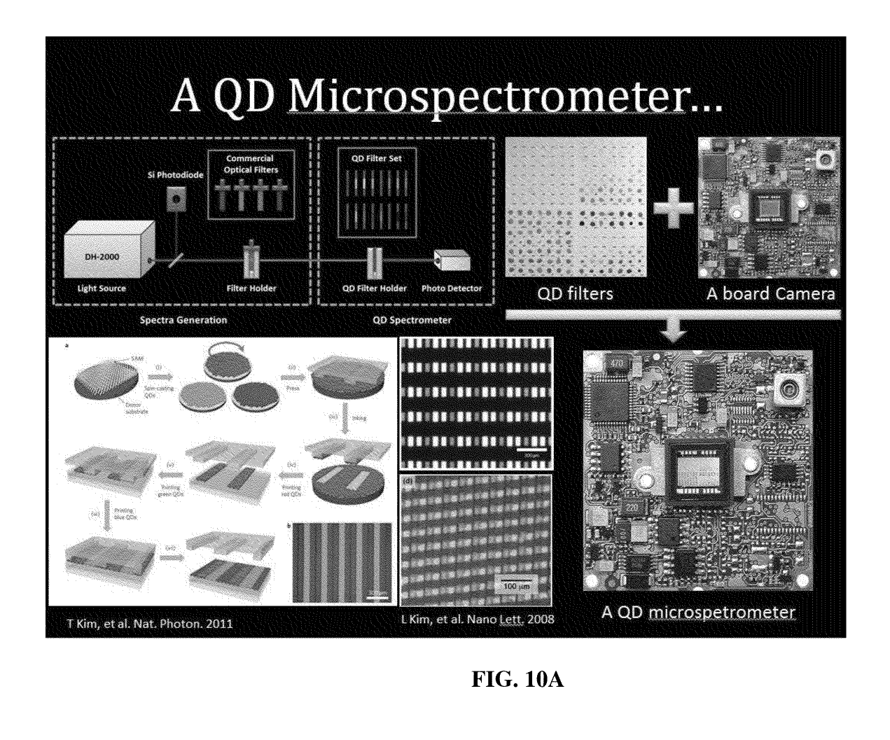

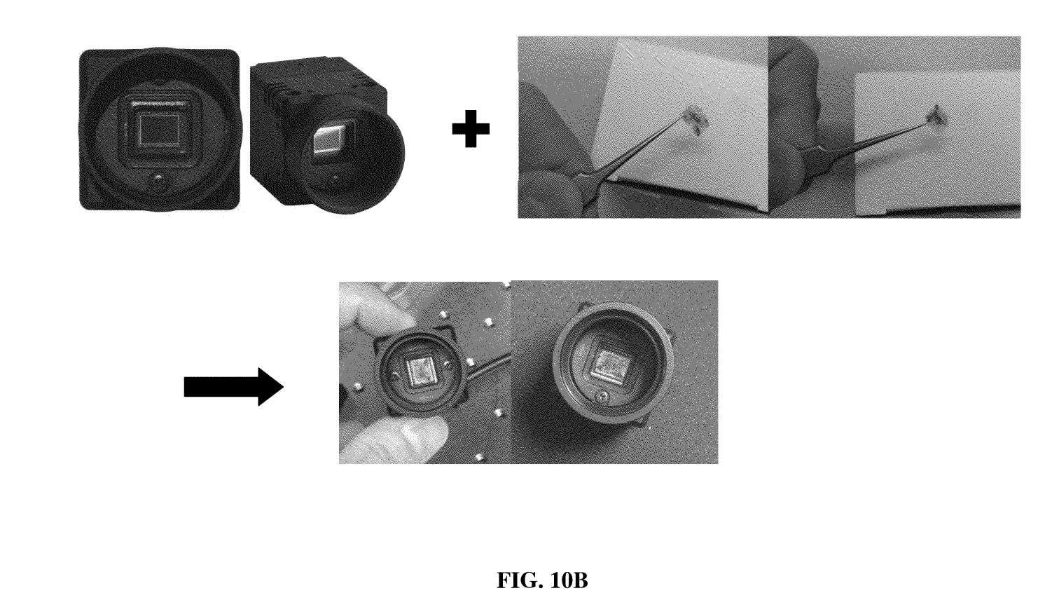

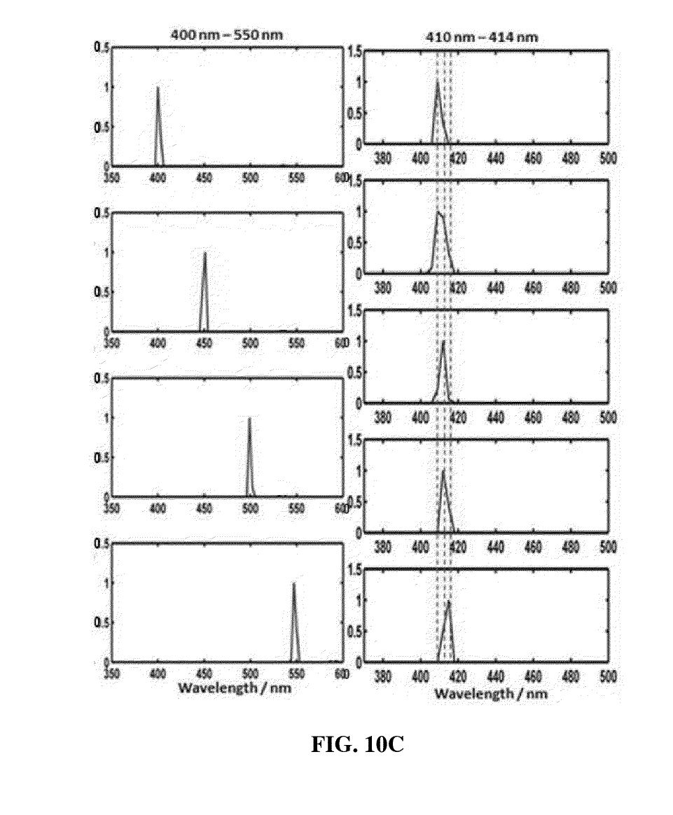

Referring to FIG. 10A, a semiconductor nanocrystal spectrometer can be integrated. Different semiconductor nanocrystals can be printed in various ways (such as by inkjet printing or contact transfer printing) on to a detector array (such as a CCD/CMOS sensor), or can be separately prepared into a standalone filtering film and then assembled onto a detector array. The semiconductor nanocrystal pattern may or may not exactly match the detector pixels. For example, a detector pixel can cover an area of more than one kind of semiconductor nanocrystals, or more than one detector pixels can cover an area of one kind of semiconductor nanocrystal. Assembly can use inkjet printing, such as using multiple printer heads (each with one or more different nanocrystals included materials) and print simultaneously or sequentially, or one printer head with multiple nanocrystals materials and print sequentially. Either substrate or the printer head/heads can be moved, or they can move together in a coordinated manner. Alternatively, the assembly can be made with a cut and paste method, by cutting small structures from a larger chunk and then paste onto a substrate for assembly with structures resulted from other nanocrystal materials. FIG. 10B shows an example where a semiconductor nanocrystal filter array made with about 150 different semiconductor nanocrystals and PMMA polymer is integrated into a CCD camera (Sentech STC-MB202USB). The spectrometer in FIG. 10B was used to measure monochromatic light at 400 nm, 450, 500, 550, 410, 411, 412, 413, and 414 nm, as shown in FIG. 10C.

As in the semiconductor nanocrystal system, it is always true that the absorption of the materials is relatively lower in the higher wavelength regions and higher in the lower wavelength regions. Therefore, it could offer additional benefits if coupled with another type of materials which have a series or absorption profiles that have relatively lower absorptions in the lower wavelength regions and higher absorption in the higher wavelength regions, which is completely opposite with the quantum dots system. When matched in certain ways and coupled to use together, they can make the response profile of the detector or detector pixel very narrow and blacks out the entire other wavelength regions. This way, the detector/detector pixel can be made to only respond to a narrow region very specifically. Making a series of detectors or detector pixels in this way, and of different wavelength regions, in a desired resolution or intensity and etc., the performance and resolution of the spectrometer may receive further benefits.

Semiconductor nanocrystals can be used as long pass filters, which can be combined with short pass filter materials, such as, for example, colored glass filters. Specifically, when semiconductor nanocrystals used as filtering materials and filtering function is heavily involved (such as the emission working scheme), the effective response profile of such detector is surprised in the lower wavelength regions more heavily than the higher wavelength regions, similar to what described above. On the other hand, when semiconductor nanocrystals are made into photodetectors themselves, running in either PV mode or photoconductive mode, the effective response profile is enhanced in the lower wavelength regions more heavily than the higher wavelength regions. Coupling these two working schemes together could produce spectral data. Specifically for example, a semiconductor nanocrystals filter (of a slightly shorter peak absorption wavelength) can be placed on top a semiconductor nanocrystal photodetector (with a semiconductor nanocrystal of a slightly longer peak absorption wavelength). Therefore, only a smaller window of wavelength region results from the difference between the two semiconductor nanocrystal peak absorption wavelengths, in a similar manner as coupling short pass and long pass filters.

Another way of using the semiconductor nanocrystal spectrometer principles is that, instead of relying solely on these detectors, it can also be used in addition to existing spectrometers, and therefore the resolution of the spectrometer can be improved without introducing more complicated optical lines and optics, so that the resolution is increased with the complexity and cost of the spectrometer do not scale up. Specifically, in a typically spectrometer, light of different wavelengths gets spread out onto an array of photodetector pixels so that each/few pixels can read intensity of a wavelength region of the light spectrum. When these detector pixels are also made into an array in the other dimension, so that each pixel on one axis (x) gets light of a different wavelength region, on the other axis (y), each pixel gets light from the same wavelength region. Then an array of different semiconductor nanocrystals filters, detectors or other structures described above are put in the y axis, then each pixel in this axis now can tell different wavelength components of this wavelength region.

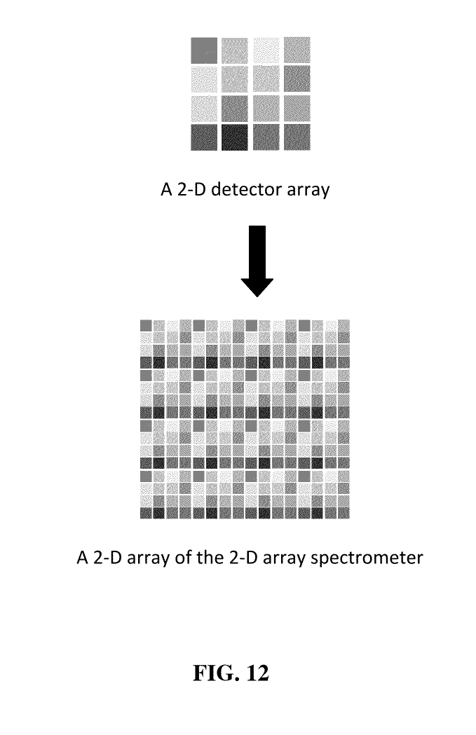

Nanocrystal spectrometers can be further developed into spectral imaging devices. For example, one way of doing this is to create a plurality of detector locations. Each detector location can include a light absorptive material capable of absorbing a predetermined wavelength of light, the light absorptive material. Each detector location can include a photosensitive element capable of providing a differential response based on differing intensity of incident light. A data recording system can then be connected to each of the photosensitive elements. The photosensitive element can included a semiconductor nanocrystal based photoconductive element. The data recording system can be configured to record the differential responses at each of the detector locations when the detector locations are illuminated by incident light. For example, a two-dimensional spectrometer can be formed into a two-dimensional array, as illustrated in FIG. 12). The detector pixels can be made into a two-dimensional array of a two-dimensional array spectrometer (i.e. a patch) to form a horizontal plate of absorptive patches where each patch has a different light absorptive characteristic. Each patch can be the same or different, depending on the application for which the spectrometer is designed. FIG. 12 shows such an example, where the number of pixels of the first level of two-dimensional array determines the spectral range and spectral resolution of the spectral images (the more pixels there are, the better resolution and larger spectral range it has), and the number of two-dimensional arrays in the second level of two-dimensional array determines the image resolution (the larger number of two-dimensional arrays there are, the larger image resolution it has).

Alternatively, such semiconductor nanocrystal spectrometers can be made directly with semiconductor nanocrystal photo detectors with different responsivity profiles, which perform the integrated function of light filtering and detection. Such semiconductor nanocrystal detectors can be further vertically stacked on top of one another similar to the tandem cell format so that the entire spectrometer would only take the space of one imaging pixel. Thereby a matrix of such pixel-sized spectrometers placed in the focal plane of an imaging lens can enable spectral imaging devices, which take spectral images with snapshots without scanning in any sense.

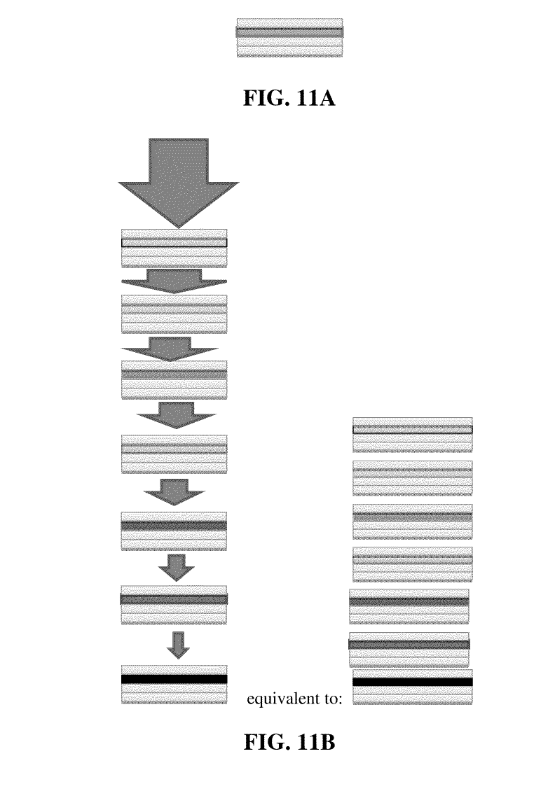

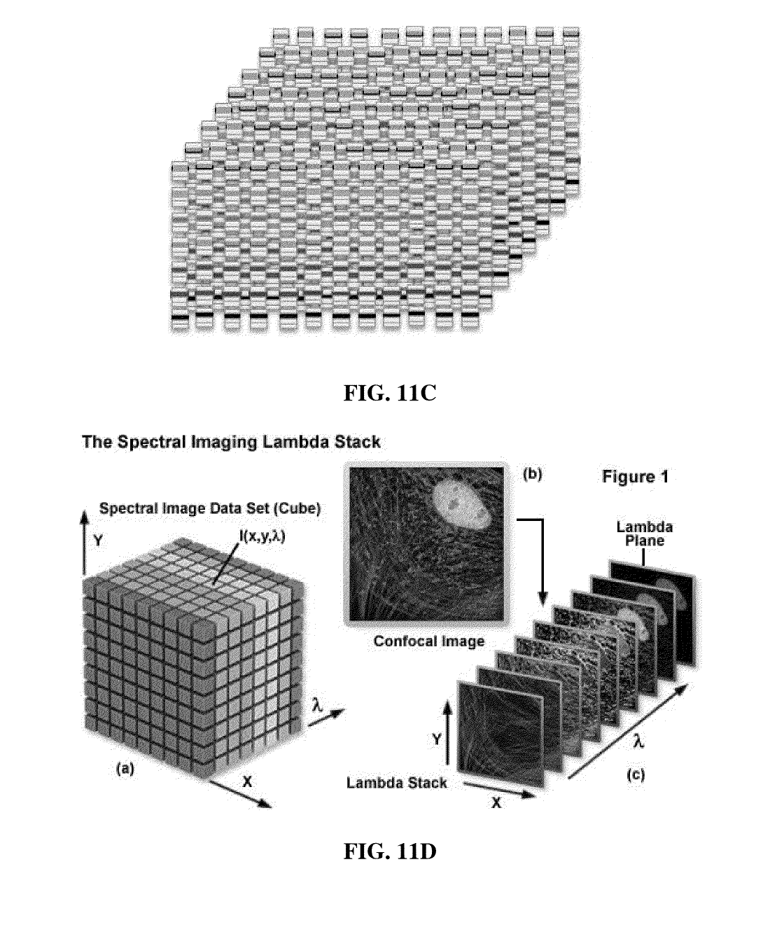

For example, a semiconductor nanocrystal detector with transparent electrodes and/or structures so that light that are not being absorbed by the semiconductor nanocrystals are mostly transmitted (FIG. 11A). The detectors can be stacked on top of one another so that light components get progressively detected. The bluer components get absorbed and detected first by the top layer/layers and the redder components get absorbed and detected later (semiconductor nanocrystal detectors formed with bluer semiconductor nanocrystals are placed above those with redder semiconductor nanocrystals). Altogether, the vertically stacked detectors can tell the light spectral component/resolve the spectrum (FIG. 11B). The stack can include 2 or more, 3 or more, 4 or more, 5 or more, 6 or more, 7 or more, or greater detectors. The stacked detectors can be repeated to form a matrix of sensors (FIG. 11C). The matrix can include 2, 3, 4, 5, 6, 7, 8, 9, 10, 11, 12, 13, 14, 15, 16, 17, 18, or greater stacks. The matrix can form a spectral imaging device similar to the spectral imaging lambda stack described at zeiss-campus.magnet.fsu.edu/tutorials/spectralimaging/lambdastack/index.html (FIG. 11D).

Ultraviolet radiation causes numerous detrimental effects to human health and safety. 3.5 million Americans are diagnosed with skin cancers yearly and 20% of the entire nation's population will get skin cancer in the course of a lifetime. Each year there are more new cases of skin cancer than the combined incidence of cancers of the breast, prostate, lung and colon. Over the past 31 years, more people have had skin cancer than all other cancers combined. About 90 percent of nonmelanoma skin cancers are associated with exposure to ultraviolet (UV) radiation from the sun. Melanoma accounts for less than five percent of skin cancer cases, but it causes more than 75 percent of skin cancer deaths. The vast majority of mutations found in melanoma are caused by ultraviolet radiation.

Up to 90 percent of the visible changes commonly attributed to aging are caused by the sun. Cosmetics and skin care products which help prevent and repair skin aging issues are themselves billion dollar industries.

Cataracts are a form of eye damage in which a loss of transparency in the lens of the eye clouds vision. If left untreated, cataracts can lead to blindness. Research has shown that UV radiation increases the likelihood of certain cataracts. Although curable with modern eye surgery, cataracts diminish the eyesight of millions of Americans and cost billions of dollars in medical care each year. Other kinds of eye damage include pterygium (tissue growth that can block vision), skin cancer around the eyes, and degeneration of the macula (the part of the retina where visual perception is most acute). All of these problems can be lessened with proper eye protection.

Accordingly, there is a need to prevent individuals' exposure to harmful levels of UV radiation, particularly from the sun. In particular, there is a need to allow individuals to conveniently and inexpensively monitor, record, and track their personal exposure to UV radiation.

Three factors of UV exposure in particular need to be measured: the intensity, duration, and action spectrum of the exposure. Action spectrum refers to the variation of the damaging effects due to the same amount of energy received at different wavelengths (a given amount of energy delivered as 240 nm light can be significantly more damaging (e.g., to skin) than the same amount of energy delivered as 400 nm light). Because UV damage is highly wavelength dependent, it is important to measure the intensity and duration of exposure at different wavelengths. It has been difficult to provide a device that can measure all three of these properties and remain affordable to consumers. Preferably, the device is affordable, highly portable or even wearable, water resistant (individuals are often exposed to UV radiation while participating in watersports), simple to use, and unobtrusive to the user.

Conversely, a certain degree of UV exposure can be beneficial. The body requires UV exposure to produce vitamin D. In addition, people enjoy sunlight, and it can be important to people's mental health and wellbeing.

A UV exposure tracking device can provide feedback to the user in real time, or can record an individual's UV exposure history over time. Real time feedback can allow a user to adapt their activities as they accrue UV exposure. UV exposure can be affected by many factors such as time of day, weather, shade, whether sunlight is mainly diffused or is reflected, and others. With real time feedback, for example, a beachgoer may choose to limit their time at the beach based on the measured level of UV exposure he or she is receiving.

The UV exposure tracking device can include a UV detector that can discriminate between different wavelengths in the UV region. The UV detector can be a semiconductor photodetector that is sensitive to UV light, and can have different responses to different UV wavelengths. In other embodiments, the UV photodetector can be a photodetector array, which can include light dispersive optical components which can spatially separate light based on wavelengths and measure separately. Alternatively, the array can temporally separate light by allowing light to pass through a crystal that has different velocities for different wavelengths first, then use a streak camera to measure different wavelengths. In other embodiments, the UV detector can be a nanocrystal spectrometer.

Exposure history can be recorded on any conventional data recording system. For portability, flash memory can be a suitable choice. Alternatively or in conjunction with onboard device memory, exposure history can be transmitted (e.g., by wireless communication) to an external storage (e.g., computer, smartphone, or the like).

Based on the individual's UV exposure history, the individual can be made aware of chronic levels of exposure, and make changes to their habits and circumstances accordingly. Numerous factors influence an individual's long term UV exposure, including local weather where they reside, personal habits, type of employment, and others. Because UV exposure can take place in many contexts (on a job site, while walking in a park, at the beach, using a tanning bed, etc.), it can be important that the UV exposure tracking device be suitable for these many contexts, by being compact, unobstrusive and rugged.

In physical form, the UV exposure tracking device can be a standalone device, and can be worn by the user, not unlike a pedometer. The UV exposure tracking device is desirably compact enough to be integrated into everyday items that people carry on a daily basis, including but not limited to: eyeglass and sunglass frames; pedometers; wrist bands; watch bands; jewelry such as bracelets, earrings, brooches, or necklace pendants; belt buckles; handbags; mobile phones; or other items or devices. In either form, the device is preferably engineered so as to have no open contact between its internal electrical components and the external environment, and to be waterproof.

The UV exposure tracking device can be provided with wireless communications, so that UV exposure data can be transmitted to other devices, such as computers or smartphones. Wireless communications avoid the need for a physical connection to other devices, which could be vulnerable to soiling, contamination, leaking, or other damage. Preferably the device is provided with solar cells to provide power to the batteries and electronics. This also avoids the need for the device to be opened (e.g., to replace batteries). The device is preferably engineered to have very low power consumption, and to have few or no switches, buttons or keys, or to provide such in a way that ensures the interior of the device is well sealed from the external environment.

The UV exposure tracking device is capable of discriminating different UV wavelengths. Solar radiation includes UVA (approx. 315 to 400 nm), UVB (approx. 280 to 315 nm) and UVC (approx. 100 to 280 nm) bands. UVB and UVC, being higher energy, are generally the more harmful bands to human health. Spectrometers are one way to provide such wavelength discrimination, but as discussed above, typical spectrometers are expensive, heavy, bulky, sensitive, and delicate instruments, very poorly suited to the needs of a personal UV exposure tracking device. Furthermore, in each wavelength region, the damaging effects can be dramatically different. Thus it is important to know not only total UV exposure but also the exposure in each of the UVA, UVB, and UVC bands. Preferably, exposure at narrower wavelength regions within those bands can also be measured. Currently, some devices can differentiate UVA/UVB exposure, but more thorough and finer wavelength differentiation is needed. Nanocrystal spectrophotometers have design parameters very suitable for a personal UV exposure tracking device including small size, good wavelength discrimination, and low cost.

Operation of the device itself can be user friendly, and can be facilitated by use in conjunction with a software user interface (UI). The software UI can be provided as a smartphone app, a computer software program, an online platform, or a combination of these. The UI can further process data recorded by the UV exposure tracking device, e.g., providing tabulated or graphical representations of a user's UV exposure history. If used in conjunction with a location services (e.g., GPS) the UI can provide the user with information about where and when higher or lower levels of UV exposure occurred. The UI can analyze the user's exposure levels and send real time notifications and suggestions via selected channels (e.g., text, push notifications, email, and the like). The UI can store and process user data statistically and sends user analytical results and suggestions based on his or her long-term exposure. The UI can be integrated or interfaced with weather predictions, and/or UV exposure collected by other users, such that the user can be altered when he or she is likely to encounter high levels of harmful UV exposure. The UI can optionally be configured to communicate a user's UV exposure data to others; for example, to a health care provider if the user is particularly susceptible to harmful effects of UV exposure.

Other uses for data collection, processing, and sharing are possible. The UI can be integrated with online services, such that the user can access his or her recorded UV exposure data from other devices (e.g., web-connected computers and smartphones).

Typically a plate reader has only one spectrometer, so wells of samples get measured sequentially. When processing a large amount of samples, the waiting time can be very long. See background information about plate readers available from Perkin Elmer (EnSpire, EnVision, VICTOR or ViewLux Plate Readers, for example).

However, if each well is equipped with a dedicated semiconductor nanocrystal spectrometer, a plate read can read all wells simultaneously. This configuration would result in the size and the cost that is comparable to traditional spectrophotometers. A semiconductor nanocrystal spectrophotometer can be integrated into devices such as medical devices, plate readers, or personal devices (e.g. smartphones) or a smartphone attachment so that it is readily accessible to individuals everywhere. See, for example, device 10 including spectrometer 100 as shown in FIG. 1A. The applications include, but not limited to food safety, drug identifications and authentications; disease diagnosis and analysis (see, for example, WO2010146588); air condition or environmental condition monitoring; personal UV monitor; color matching pulse/oxygen monitoring; spectral images; industrial production monitoring and quality control; lab research tools; chemical and substance detection and analysis for military/security; forensic analysis; and analysis tools for farming.

Using ultra small detector arrays, such as one mentioned above (˜1 mm*1 mm area, from Awaiba), semiconductor nanocrystal spectrometers can be made into about the same small size. The facilitating electronics can be packaged with the spectrometer, which could increase the overall size of the device, or could be separated packaged and connected with the detecting unit via wired or wireless connections. For instance, such as in the way Awaiba nanoeye cameras are connected with external electronics with wires. These spectrometers can be mounted on to biopsy probes to have non-invasive or minimally invasive diagnostics and facilitating surgical procedures. The spectrometers can be integrated into endoscopes such as the Medigus System or Capsule endoscope to help diagnosis. The spectrometers can also be integrated into other diagnostic and surgical tools (such as for cancers) to help with these procedures. There have been a lot of research results showing the use of spectroscopic information to do diagnosis. See, for example, Quantitative Optical Spectroscopy for Tissue Diagnosis, Annual Review of Physical Chemistry, Vol. 47: 555-606, 1996, which is incorporated by reference in its entirety. See also WO2010146588, which is incorporated by reference in its entirety.

Other embodiments are within the scope of the following claims.

What is claimed is:

1. A spectrometer comprising:
a plurality of detector locations, wherein each detector location includes a plurality of semiconductor nanocrystals capable of absorbing a predetermined wavelength of light, and wherein each detector location includes a photosensitive element capable of providing a differential response based on differing intensity of incident light; and
a data recording system connected to each of the photosensitive elements, wherein the data recording system is configured to record the differential responses at each of the detector locations when the detector locations are illuminated by incident light.

2. The spectrometer of claim 1, wherein the plurality of semiconductor nanocrystals at each detector location is capable of absorbing a different predetermined wavelength of light.

3. The spectrometer of claim 1, wherein the photosensitive elements are photovoltaic cells.

4. The spectrometer of claim 1, wherein the photosensitive elements are photoconductors.

5. The spectrometer of claim 1, wherein the semiconductor nanocrystals, after absorbing the predetermined wavelength of light, are capable of emitting a distinct wavelength of light, and wherein the photosensitive element is sensitive to the distinct wavelength of light.

6. The spectrometer of claim 1, wherein the semiconductor nanocrystals are configured to absorb substantially all of the predetermined wavelength of light incident at a particular detector location, and substantially incapable of emitting a distinct wavelength of light.

7. A method of recording a spectrogram, comprising:
providing a spectrometer comprising:
a plurality of detector locations, wherein each detector location includes a plurality of semiconductor nanocrystals capable of absorbing a predetermined wavelength of light, and wherein each detector location includes a photosensitive element capable of providing a differential response based on differing intensity of incident light; and
a data recording system connected to each of the photosensitive elements, wherein the data recording system is configured to record the differential responses at each of the detector locations when the detector locations are illuminated by incident light;
illuminating the plurality of detector locations with incident light;
recording the differential responses at each of the detector locations; and
determining the intensity of a particular wavelength of incident light based on the recorded differential responses at each of the detector locations.

8. A personal UV exposure tracking device, comprising:
a UV detector that can discriminate between different wavelengths in the UV region; and
a data recording system configured to record differential responses to the different wavelengths in the UV region when the detector locations are illuminated by incident light.

9. The personal UV exposure tracking device of claim 8, wherein the UV detector is a UV sensitive semiconductor photodetector.

10. The personal UV exposure tracking device of claim 8, wherein the UV photodetector is a photodetector array.

11. The personal UV exposure tracking device of claim 8, wherein the UV detector is a nanocrystal spectrometer.

12. The personal UV exposure tracking device of claim 11, wherein the nanocrystal spectrometer includes:
a plurality of detector locations, wherein each detector location includes a plurality of semiconductor nanocrystals capable of absorbing a predetermined wavelength of light, and wherein each detector location includes a photosensitive element capable of providing a differential response based on differing intensity of incident light; and
the data recording system is connected to each of the photosensitive elements, wherein the data recording system is configured to record the differential responses at each of the detector locations when the detector locations are illuminated by incident light.

13. The personal UV exposure tracking device of claim 8, wherein the spectrometer is configured to measure the intensity of one or more UV wavelengths of incident light.

14. The personal UV exposure tracking device of claim 13, wherein the spectrometer is configured to measure the intensity of UVA, UVB, and UVC wavelengths of incident light.

15. The personal UV exposure tracking device of claim 8, further comprising a data storage component configured to record the measured intensity of one or more UV wavelengths of incident light.

16. The personal UV exposure tracking device of claim 8, further comprising a wireless data communication system configured to transmit the measured intensity of one or more UV wavelengths of incident light to an external computing device.

17. The personal UV exposure tracking device of claim 8, wherein the device is configured to provide a real time measurement of UV exposure to a user.

18. The personal UV exposure tracking device of claim 8, wherein the device is configured to provide a historical report of UV exposure to a user.

19. The personal UV exposure tracking device of claim 8, wherein the device is integrated in a portable personal item.

20. The personal UV exposure tracking device of claim 19, wherein the portable personal item is waterproof.

21. A spectrometer comprising:
a plurality of detector locations, wherein each detector location includes a light absorptive material capable of absorbing a predetermined wavelength of light, the light absorptive material being selected from the group consisting of a semiconductor nanocrystal, a carbon nanotube and a photonic crystal, and wherein each detector location includes a photosensitive element capable of providing a differential response based on differing intensity of incident light; and
a data recording system connected to each of the photosensitive elements, wherein the data recording system is configured to record the differential responses at each of the detector locations when the detector locations are illuminated by incident light.

22. The spectrometer of claim 21, wherein the plurality of detector locations includes a filter including a semiconductor nanocrystal.

23. The spectrometer of claim 21, wherein the photosensitive element includes a semiconductor nanocrystal.

24. The spectrometer of claim 21, wherein the plurality of detector locations includes a filter including a first semiconductor nanocrystal through which light passes prior to the photosensitive element, the photosensitive element including a second semiconductor nanocrystal.

25. A method of making a spectrometer comprising:
creating a plurality of detector locations, wherein each detector location includes a light absorptive material capable of absorbing a predetermined wavelength of light, the light absorptive material being selected from the group consisting of a semiconductor nanocrystal, a carbon nanotube and a photonic crystal, and wherein each detector location includes a photosensitive element capable of providing a differential response based on differing intensity of incident light; and
connecting a data recording system to each of the photosensitive elements, wherein the data recording system is configured to record the differential responses at each of the detector locations when the detector locations are illuminated by incident light.

26. The method of claim 25, wherein creating the plurality of detector locations includes inkjet printing or contact transfer printing the light absorptive material on a substrate.

27. The method of claim 25, wherein creating the plurality of detector locations includes forming a vertical stack of a plurality of semiconductor nanocrystal photo detectors.

28. The method of claim 27, further comprising assembling a plurality of vertical stacks to form a matrix of vertical stacks.

29. A method of making a spectral imaging device comprising:
creating a plurality of detector locations, wherein each detector location includes a light absorptive material capable of absorbing a predetermined wavelength of light, the light absorptive material, and wherein each detector location includes a photosensitive element capable of providing a differential response based on differing intensity of incident light; and
connecting a data recording system to each of the photosensitive elements, wherein the data recording system is configured to record the differential responses at each of the detector locations when the detector locations are illuminated by incident light.

30. The method of claim 29, wherein creating the plurality of detector locations includes forming a vertical stack of absorptive layers, each absorptive layer having a different light absorptive characteristic.

31. The method of claim 29, further comprising assembling a plurality of vertical stacks to form a matrix of vertical stacks.

32. The method of claim 29, wherein creating the plurality of detector locations includes forming a horizontal plate of absorptive patches, each patch having a different light absorptive characteristic.

33. The method of claim 29, wherein the light absorptive material is selected from the group consisting of a semiconductor nanocrystal, a carbon nanotube and a photonic crystal.

34. A plate reader comprising a plurality of spectrometers and a plurality of wells, wherein each well is associated with a unique spectrometer of the plurality of spectrometers, each spectrometer comprising a plurality of detector locations, wherein each detector location includes a light absorptive material capable of absorbing a predetermined wavelength of light, the light absorptive material, and wherein each detector location includes a photosensitive element capable of providing a differential response based on differing intensity of incident light; and
a data recording system to each of the photosensitive elements, wherein the data recording system is configured to record the differential responses at each of the detector locations when the detector locations are illuminated by incident light.

35. A plate reader of claim 34, wherein the light absorptive material is selected from the group consisting of a semiconductor nanocrystal, a carbon nanotube and a photonic crystal.

36. A personal device comprising a spectrometer comprising:
a plurality of detector locations, wherein each detector location includes a plurality of semiconductor nanocrystals capable of absorbing a predetermined wavelength of light, and wherein each detector location includes a photosensitive element capable of providing a differential response based on differing intensity of incident light; and
a data recording system connected to each of the photosensitive elements, wherein the data recording system is configured to record the differential responses at each of the detector locations when the detector locations are illuminated by incident light.

37. A personal device of claim 36, wherein the device is a smartphone or smartphone attachment.

38. A medical device comprising a spectrometer comprising:
a plurality of detector locations, wherein each detector location includes a plurality of semiconductor nanocrystals capable of absorbing a predetermined wavelength of light, and wherein each detector location includes a photosensitive element capable of providing a differential response based on differing intensity of incident light; and
a data recording system connected to each of the photosensitive elements, wherein the data recording system is configured to record the differential responses at each of the detector locations when the detector locations are illuminated by incident light.
